(19) United States
(12) Patent Application Publication
(10) Pub. No.: US 2025/0202661 A1
(43) Pub. Date: Jun. 19, 2025

(54) ENCODER SELECTION FOR NETWORK CODING

(71) Applicant: QUALCOMM Incorporated, San Diego, CA (US)

(72) Inventors: Guangyi LIU, Shanghai (CN); Jian LI, Shanghai (CN); Gabi SARKIS, San Diego, CA (US)

(21) Appl. No.: 18/851,607

(22) PCT Filed: May 27, 2022
(86) PCT No.: PCT/CN2022/095442

§ 371 Date: Sep. 26, 2024

(51) Int. Cl. H04L 5/00; H04W 72/0446

(52) U.S. Cl. CPC H04L 5/0053; H04W 72/0446

(57) ABSTRACT

Methods, systems, and devices for wireless communications are described. A user equipment (UE) may transmit, to one or more wireless devices, an announcement message including a request for at least one of the wireless devices to serve as a network coding device for retransmitting packets originally transmitted from the UE. In response to the announcement message, the UE may receive one or more confirmation messages, where each confirmation message may indicate a wireless device that is capable of serving as the network coding device. The UE may select a set of one or more network coding devices from the one or more wireless devices based on the one or more confirmation messages. In some examples, the UE may transmit, to the set of one or more network coding devices, a second announcement message indicating that the set of one or more network coding devices has been selected.

### CROSS REFERENCE

The present Application is a 371 national stage filing of International PCT Application No. PCT/CN2022/095442 by LIU et al. entitled “ENCODER SELECTION FOR NETWORK CODING,” filed May 27, 2022, which is assigned to the assignee hereof, and which is expressly incorporated by reference in its entirety herein.

### FIELD OF TECHNOLOGY

The following relates to wireless communications, including encoder selection for network coding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, such as base stations, each supporting wireless communications for communication devices, which may be known as user equipment (UE). Some wireless communications systems may support retransmissions of a packet via a transmitting wireless device (e.g., a UE, road-side unit (RSU), relay device) to improve the likelihood that the packet is successfully received by one or more receiving wireless devices.

### SUMMARY

The described techniques relate to improved methods, systems, devices, and apparatuses that support encoder selection for network coding. For example, the described techniques provide for the selection of one or more network coding devices by a user equipment (UE) or other wireless device. In some aspects, the UE may initiate a network coding device selection procedure by transmitting an announcement message to one or more wireless devices, where the announcement message may include a request for at least one device to serve as a network coding device (e.g., a network encoder). The announcement message may indicate a quantity of encoders requested, as well as one or more thresholds that a suitable encoder may satisfy. In response to the announcement message, the UE may receive one or more confirmation messages that indicate at least one device that may serve as a network coding device. For example, each confirmation message may include a vote for (e.g., a vote nominating) a particular device to serve as the network coding device, and the UE may determine a quantity of votes in favor of each device based on the confirmation messages (e.g., the UE may calculate a total number of votes for each device). Additionally, or alternatively, a confirmation message may include an indication (e.g., a claim) that a device will serve as the network coding device, which, in some examples, may prohibit one or more other devices from serving as the network coding device. In such cases, the claim may be transmitted after a random backoff time or after a time period based on some parameters associated with the device transmitting the claim (e.g., which may provide some priority to devices currently serving as a network coding device). In any case, the UE may select a network coding device based on the votes or one or more received claims. The selection of the network coding device may be based on the network coding device satisfying the one or more thresholds.

A method for wireless communication at a user equipment (UE) is described. The method may include transmitting, to one or more wireless devices, an announcement message including a request for at least one of the one or more wireless devices to serve as a network coding device for retransmitting packets originally transmitted from the UE, receiving one or more confirmation messages in response to the announcement message, where each confirmation message of the one or more confirmation messages indicates a wireless device that is capable of serving as the network coding device, and selecting a set of one or more network coding devices from the one or more wireless devices based on the one or more confirmation messages.

An apparatus for wireless communication at a UE is described. The apparatus may include a processor, memory coupled with the processor, and instructions stored in the memory. The instructions may be executable by the processor to cause the apparatus to transmit, to one or more wireless devices, an announcement message including a request for at least one of the one or more wireless devices to serve as a network coding device for retransmitting packets originally transmitted from the UE, receive one or more confirmation messages in response to the announcement message, where each confirmation message of the one or more confirmation messages indicates a wireless device that is capable of serving as the network coding device, and select a set of one or more network coding devices from the one or more wireless devices based on the one or more confirmation messages.

Another apparatus for wireless communication at a UE is described. The apparatus may include means for transmitting, to one or more wireless devices, an announcement message including a request for at least one of the one or more wireless devices to serve as a network coding device for retransmitting packets originally transmitted from the UE, means for receiving one or more confirmation messages in response to the announcement message, where each confirmation message of the one or more confirmation messages indicates a wireless device that is capable of serving as the network coding device, and means for selecting a set of one or more network coding devices from the one or more wireless devices based on the one or more confirmation messages.

A non-transitory computer-readable medium storing code for wireless communication at a UE is described. The code may include instructions executable by a processor to transmit, to one or more wireless devices, an announcement message including a request for at least one of the one or more wireless devices to serve as a network coding device for retransmitting packets originally transmitted from the UE, receive one or more confirmation messages in response to the announcement message, where each confirmation message of the one or more confirmation messages indicates a wireless device that is capable of serving as the network coding device, and select a set of one or more network coding devices from the one or more wireless devices based on the one or more confirmation messages.

In some examples of the method, apparatuses, and non-transitory computer-readable medium described herein, each confirmation message of the one or more confirmation messages includes a vote nominating the wireless device to serve as the network coding device and the method, apparatuses, and non-transitory computer-readable medium may include further operations, features, means, or instructions for calculating, by the UE, a quantity of votes nominating respective wireless devices indicated via the one or more confirmation messages, where the set of one or more network coding devices may be selected based on the quantity of votes nominating each of the respective wireless devices.

In some examples of the method, apparatuses, and non-transitory computer-readable medium described herein, selecting the set of one or more network coding devices may include operations, features, means, or instructions for calculating, by the UE, that a first wireless device and a second wireless device of the one or more wireless devices may have a same quantity of votes based on the one or more confirmation messages and randomly selecting the first wireless device or the second wireless device in the set of one or more network coding devices based on the calculation.

In some examples of the method, apparatuses, and non-transitory computer-readable medium described herein, each confirmation message further includes an identifier of the wireless device, a weighted value of the wireless device, an indication that the confirmation message includes the vote, or any combination thereof.

In some examples of the method, apparatuses, and non-transitory computer-readable medium described herein, the one or more confirmation messages may be received during a first time duration and the method, apparatuses, and non-transitory computer-readable medium may include further operations, features, means, or instructions for transmitting, to the set of one or more network coding devices, a second announcement message indicating that the set of one or more network coding devices may have been selected, where the second announcement message may be transmitted after the first time duration and includes an identifier for each network coding device of the set of one or more network coding devices.

Some examples of the method, apparatuses, and non-transitory computer-readable medium described herein may further include operations, features, means, or instructions for receiving, from at least one selected network coding device of the set of one or more network coding devices, a second confirmation message in response to the second announcement message, the second confirmation message indicating that the at least one selected network coding device will serve as the network coding device for retransmitting the packets originally transmitted from the UE.

Some examples of the method, apparatuses, and non-transitory computer-readable medium described herein may further include operations, features, means, or instructions for determining an absence of a second confirmation message received from at least one network coding device of the set of one or more network coding devices in response to the second announcement message and transmitting a third announcement message based on the absence of the second confirmation message, the third announcement message including an indication of a modified set of one or more network coding devices.

Some examples of the method, apparatuses, and non-transitory computer-readable medium described herein may further include operations, features, means, or instructions for determining that a quantity of second confirmation messages from the set of one or more network coding devices fails to satisfy a threshold quantity of confirmation messages and transmitting a third announcement message based on the quantity of the second confirmation messages failing to satisfy the threshold quantity of confirmation messages, the third announcement message including an indication of a modified set of one or more network coding devices.

In some examples of the method, apparatuses, and non-transitory computer-readable medium described herein, receiving the one or more confirmation messages may include operations, features, means, or instructions for receiving a first confirmation message from at least one wireless device after a backoff time, the first confirmation message indicating that the at least one wireless device will serve as the network coding device, where the at least one wireless device may be selected for the set of one or more network coding devices based on the first confirmation message, where the first confirmation message precludes other wireless devices from serving as the network coding device.

Some examples of the method, apparatuses, and non-transitory computer-readable medium described herein may further include operations, features, means, or instructions for transmitting a second announcement message indicating that the set of one or more network coding devices may have been selected based on receiving the first confirmation message.

In some examples of the method, apparatuses, and non-transitory computer-readable medium described herein, the first confirmation message includes an indication that the first confirmation message may be associated with a claim for the at least one wireless device to be the network coding device and an identifier of the at least one wireless device.

In some examples of the method, apparatuses, and non-transitory computer-readable medium described herein, and the method, apparatuses, and non-transitory computer-readable medium may include further operations, features, means, or instructions for the backoff time includes a time duration that may be calculated based on a parameter, a score, and a slot duration, where the score may be based on a weighted sum of criteria indicated by the announcement message for which the at least one wireless device satisfies.

Some examples of the method, apparatuses, and non-transitory computer-readable medium described herein may further include operations, features, means, or instructions for storing a list of the set of one or more network coding devices based on selecting the set of one or more network coding devices.

Some examples of the method, apparatuses, and non-transitory computer-readable medium described herein may further include operations, features, means, or instructions for transmitting a quantity of network coding request messages to one or more network coding devices, where transmitting the announcement message may be triggered via an absence of one or more acceptance messages in response to the quantity of network coding request messages.

Some examples of the method, apparatuses, and non-transitory computer-readable medium described herein may further include operations, features, means, or instructions for determining an absence of network coding packets, or encoder claiming packets, or both, for a second time duration, where transmitting the announcement message may be triggered via the absence of the network coding packets, or the encoder claiming packets, or both, for the second time duration.

Some examples of the method, apparatuses, and non-transitory computer-readable medium described herein may further include operations, features, means, or instructions for receiving one or more announcement messages from one or more other UEs during a third time duration and refraining from transmitting a second announcement message based on the one or more announcement messages received during the third time duration.

Some examples of the method, apparatuses, and non-transitory computer-readable medium described herein may further include operations, features, means, or instructions for monitoring for one or more existing network coding devices and determining an absence of an existing network coding device based on the monitoring, where transmitting the announcement message may be based on determining the absence of the existing network coding device.

In some examples of the method, apparatuses, and non-transitory computer-readable medium described herein, each network coding device of the set of one or more network coding devices satisfy one or more criteria indicated via the announcement message.

In some examples of the method, apparatuses, and non-transitory computer-readable medium described herein, the one or more criteria include a speed threshold, a remaining power threshold, an available buffer size threshold, a computational load threshold, a reference signal received power threshold, or any combination thereof.

In some examples of the method, apparatuses, and non-transitory computer-readable medium described herein, the announcement message includes an indication of a quantity of network coding devices requested from the UE and selecting the set of one or more network coding devices may be based on the quantity of network coding devices requested from the UE.

In some examples of the method, apparatuses, and non-transitory computer-readable medium described herein, the announcement message includes a network coding request message including a request for retransmitting the packets originally transmitted from the UE.

A method for wireless communication at a wireless device is described. The method may include receiving, from a UE, an announcement message including a request for at least one wireless device to serve as a network coding device for retransmitting packets originally transmitted from the UE and transmitting, to the UE, a confirmation message in response to the announcement message, where the confirmation message indicates that the wireless device or another wireless device is capable of serving as the network coding device.

An apparatus for wireless communication at a wireless device is described. The apparatus may include a processor, memory coupled with the processor, and instructions stored in the memory. The instructions may be executable by the processor to cause the apparatus to receive, from a UE, an announcement message including a request for at least one wireless device to serve as a network coding device for retransmitting packets originally transmitted from the UE and transmit, to the UE, a confirmation message in response to the announcement message, where the confirmation message indicates that the wireless device or another wireless device is capable of serving as the network coding device.

Another apparatus for wireless communication at a wireless device is described. The apparatus may include means for receiving, from a UE, an announcement message including a request for at least one wireless device to serve as a network coding device for retransmitting packets originally transmitted from the UE and means for transmitting, to the UE, a confirmation message in response to the announcement message, where the confirmation message indicates that the wireless device or another wireless device is capable of serving as the network coding device.

A non-transitory computer-readable medium storing code for wireless communication at a wireless device is described. The code may include instructions executable by a processor to receive, from a UE, an announcement message including a request for at least one wireless device to serve as a network coding device for retransmitting packets originally transmitted from the UE and transmit, to the UE, a confirmation message in response to the announcement message, where the confirmation message indicates that the wireless device or another wireless device is capable of serving as the network coding device.

In some examples of the method, apparatuses, and non-transitory computer-readable medium described herein, the confirmation message includes a vote nominating the wireless device or the other wireless device to serve as the network coding device.

Some examples of the method, apparatuses, and non-transitory computer-readable medium described herein may further include operations, features, means, or instructions for receiving, from the UE, a second announcement message indicating that a set of one or more network coding devices may have been selected, where the second announcement message may be transmitted after a first time duration for selecting network coding devices.

In some examples of the method, apparatuses, and non-transitory computer-readable medium described herein, the wireless device may be included in the set of one or more network coding devices for the UE and the method, apparatuses, and non-transitory computer-readable medium may include further operations, features, means, or instructions for transmitting, to the UE, a second confirmation message in response to the second announcement message, the second confirmation message indicating that the wireless device will serve as the network coding device for retransmitting the packets originally transmitted from the UE.

In some examples of the method, apparatuses, and non-transitory computer-readable medium described herein, transmitting the confirmation message may include operations, features, means, or instructions for transmitting the confirmation message after a backoff time, the confirmation message indicating that the wireless device will serve as the network coding device, where the wireless device serves as the network coding device for the UE based on the confirmation message.

In some examples of the method, apparatuses, and non-transitory computer-readable medium described herein, randomly selecting the backoff time from a range of time durations and computing the backoff time based on a parameter, a score, and a slot duration.

In some examples of the method, apparatuses, and non-transitory computer-readable medium described herein, the backoff time may be equal to a predefined value based on the wireless device serving as an existing network coding device.

### BRIEF DESCRIPTION OF THE DRAWINGS

FIG. 1 illustrates an example of a wireless communications system that supports encoder selection for network coding in accordance with one or more aspects of the present disclosure.

FIG. 2 illustrates an example of retransmissions using network coding that supports encoder selection for network coding in accordance with one or more aspects of the present disclosure.

FIG. 3 illustrates an example of a process flow in a system that supports encoder selection for network coding in accordance with one or more aspects of the present disclosure.

FIG. 4 illustrates an example of a wireless communications system that supports encoder selection for network coding in accordance with one or more aspects of the present disclosure.

FIG. 5 illustrates an example of a process flow in a system that supports encoder selection for network coding in accordance with one or more aspects of the present disclosure.

FIGS. 6 and 7 show block diagrams of devices that support encoder selection for network coding in accordance with one or more aspects of the present disclosure.

FIG. 8 shows a block diagram of a communications manager that supports encoder selection for network coding in accordance with one or more aspects of the present disclosure.

FIG. 9 shows a diagram of a system including a device that supports encoder selection for network coding in accordance with one or more aspects of the present disclosure.

FIGS. 10 and 11 show block diagrams of devices that support encoder selection for network coding in accordance with one or more aspects of the present disclosure.

FIG. 12 shows a block diagram of a communications manager that supports encoder selection for network coding in accordance with one or more aspects of the present disclosure.

FIG. 13 shows a diagram of a system including a device that supports encoder selection for network coding in accordance with one or more aspects of the present disclosure.

FIGS. 14 through 20 show flowcharts illustrating methods that support encoder selection for network coding in accordance with one or more aspects of the present disclosure.

### DETAILED DESCRIPTION

Some wireless communications systems may support retransmissions of a packet from a source (e.g., transmitting) device (e.g., a user equipment (UE) or road-side unit (RSU)) to improve the likelihood that the packet is successfully received at one or more receiving devices (e.g., another UE, another road-side unit (RSU), a relay device, or a network entity). In some such systems, however, the overhead associated with retransmitting packets may be high. To minimize overhead, a wireless communications system may include network coding devices that may aggregate packets from multiple wireless devices into a single retransmission. For example, some devices, such as UEs, RSUs, relay devices, and network entities, in a vehicle-to-everything (V2X) wireless communications system may be enabled to perform network coding which may increase system capacity, reduce overhead, and improve resource utilization by reducing a number of retransmissions performed in the system.

One or more source UEs may transmit a data packet, where one or more retransmissions of the data packet may be performed via network coding (e.g., performed by a network coding device (e.g., another UE, an RSU, a relay device, a network entity)), thereby streamlining retransmissions from the one or more source UEs into a single retransmission. In some aspects, a network coding device may be referred to as an encoder, a network encoder, a network encoding device, a network coding encoder, or some similar terminology. In some examples, there may be one or multiple devices available to serve as network encoders in an area or location, which may be referred to as distributed network coding. But in some cases, not all of the devices may be suitable for serving as network encoders. Thus, based on various parameters, a suitable network coding device may be selected by a central network entity or a central controller. In some communications modes (e.g., transmission mode 2 for sidelink communications), however, there may not be a central network entity or central controller available to perform the network coding device selection. As such, techniques enabling one or more wireless devices in the V2X communications system to performing initial encoder selection (e.g., using transmission mode 2) may be desirable.

As described herein, a UE (or other device) may initiate network coding device selection by transmitting an announcement message, for example, via a control channel (e.g., physical sidelink control channel (PSCCH), via a physical uplink control channel (PUCCH)), or both. The announcement message may indicate a number of network coding devices requested and one or more thresholds a suitable encoder may satisfy. In some cases, the announcement message may be included in a request for network encoded transmissions. That is, the announcement message may additionally include a request for a network coding device to retransmit one or more packets through network coding techniques.

The UE may select one or more suitable network coding devices via a ballot or a claim received from a device that may serve as the network coding device. For example, in response to the announcement message, each device (e.g., any combination of UEs, RSUs, relay devices, network entities) may transmit a vote to the UE. The UE may select a network coding device based on the votes and may transmit a second announcement including an indication of the selected (e.g., suitable) network coding devices. Additionally, or alternatively, in response to the announcement message, a device that is capable of serving as a network coding device may transmit a claim (e.g., indicating or claiming that the device transmitting the claim is a suitable encoder) after a randomly-selected backoff time (e.g., a slot) T. The claim message may preclude other devices from claiming the role of network coding device beyond a number of requested network coding devices. That is, claim messages received from a first device may preclude a second device from transmitting a claim when one network coding devices are requested by the UE. In another example, in response to the announcement message, a device that is capable of serving as a network coding device may transmit a claim after a computed backoff time, T. In some examples, the backoff time may be relatively shorter when the device transmitting the claim is a relatively more suitable network coding device (e.g., satisfies relatively more thresholds, satisfies one or more thresholds to a greater degree, currently serves as a network coding device, or the like). Likewise, relatively less-suitable network coding devices may wait for a longer backoff time before transmitting a claim, which may help ensure the UE identifies the network coding device(s) that satisfy the various thresholds indicated by the announcement message.

Aspects of the disclosure are initially described in the context of wireless communications systems. Examples of processes and signaling exchanges that support network coding handover between encoders are then described. Aspects of the disclosure are further illustrated by and described with reference to apparatus diagrams, system diagrams, and flowcharts that relate to encoder selection for network coding.

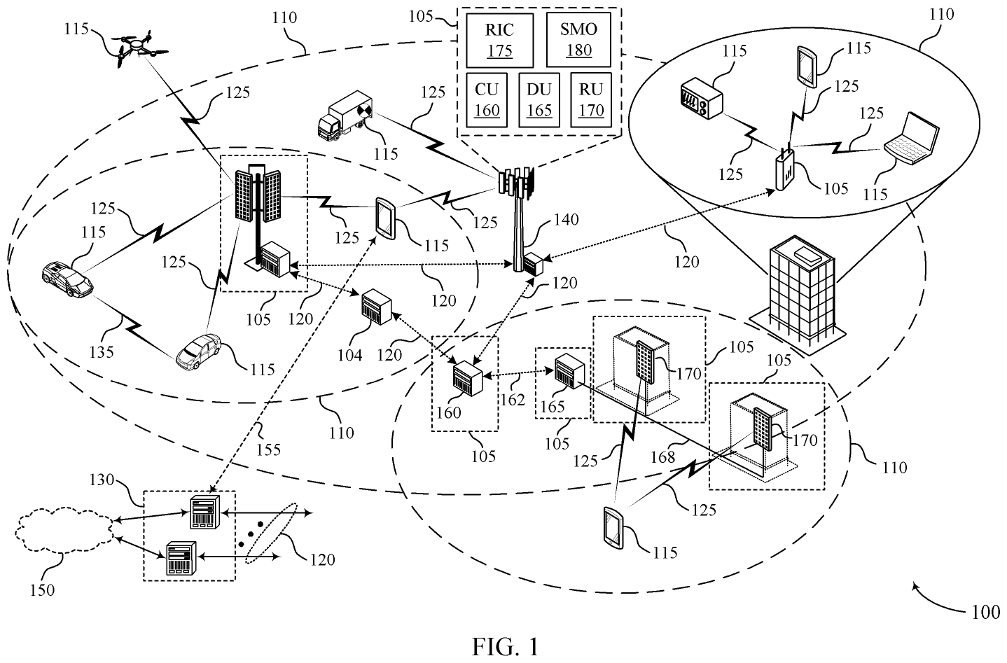

FIG. 1 illustrates an example of a wireless communications system 100 that supports encoder selection for network coding in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support encoder selection for network coding as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1.M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

Sidelink communications may enable a UE 115 to communicate using resources on a sidelink channel in accordance with different transmission modes. For example, using a first transmission mode (e.g., mode 1), a network entity may indicate (e.g., via DCI) resources to be used by a transmitting UE 115 for communications over the sidelink channel. Using a second transmission mode (e.g., mode 2), the transmitting UE 115 may select one or more resources from a pool of resources for communications over the sidelink channel, where the transmitting UE 115 may, in some cases, select the resources when the UE 115 is outside of coverage of the network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some cases, because the wireless communications system 100 may support retransmissions of a packet by a transmitting device, the overhead in the wireless communications system 100 may increase as the number of transmitting devices in the wireless communications system 100 increases. To minimize overhead, the wireless communications system 100 may include network coding devices (e.g., network encoders) that may aggregate packets from multiple wireless devices in a single retransmission. As a result, multiple retransmissions may be replaced by a single retransmission using network coding, and the overhead of retransmissions in the wireless communications system 100 may be reduced.

For distributed network coding, there may be one or multiple devices selected to be network encoders in an area. In some examples, however, not all available devices may be suitable for serving as network coding devices. Thus, based on various factors, a suitable network coding device may be selected by a central network entity 105 or a central controller. In some cases, wireless communications system 100 may support communications techniques (e.g., mode 2 sidelink communications) in which there may not be a central network entity 105 or central controller for performing the network coding device selection. As such, one or more wireless devices (e.g., UE 115, RSU) in the V2X communications system may perform initial encoder selection (e.g., in mode 2 communications).

For example, a UE 115 (or other device) may initiate network coding device selection by transmitting an announcement message via a control channel (e.g., PSCCH, PUCCH). The announcement message may indicate a number of network coding devices requested and one or more thresholds a suitable encoder may satisfy. In some cases, the announcement message may be included in a request for a transmission to be network encoded (e.g., retransmitted using network coding). The UE 115 may select a suitable encoder via a ballot or a claim received from a device that may serve as the network coding device.

For example, in response to the announcement message, each device (e.g., any combination of UEs 115, RSUs, relay devices, network entities) may transmit a vote to the UE 115. The UE 115 may select a network coding device based on the votes and may transmit a second announcement including an indication of the selected (e.g., suitable) network coding devices. Additionally, or alternatively, in response to the announcement message, a device that is capable of serving as a network coding device may transmit a claim (e.g., indicating or claiming that the device transmitting the claim is a suitable encoder) after a randomly-selected backoff time (e.g., a slot or other time duration) T. The claim message may preclude one or more other devices from claiming the role of network coding device beyond a number of requested network coding devices. That is, claim messages received from a first device may preclude a second device from transmitting a claim when one network coding devices are requested by the UE 115. In another example, in response to the announcement message, a device that is capable of serving as a network coding device may transmit a claim after a computed backoff time, T. In some such examples, the computed backoff time may be relatively shorter when the device transmitting the claim is a relatively more suitable network coding device (e.g., satisfies relatively more thresholds, satisfies one or more thresholds to a greater degree, currently serves as a network coding device). Likewise, relatively less-suitable network coding devices may wait for a longer backoff time before transmitting a claim. The actions performed by the UE 115 for network coding device selection in the wireless communications system 100 may thus increase system capacity, reduce overhead, and improve resource utilization by reducing a number of retransmissions performed in the system.

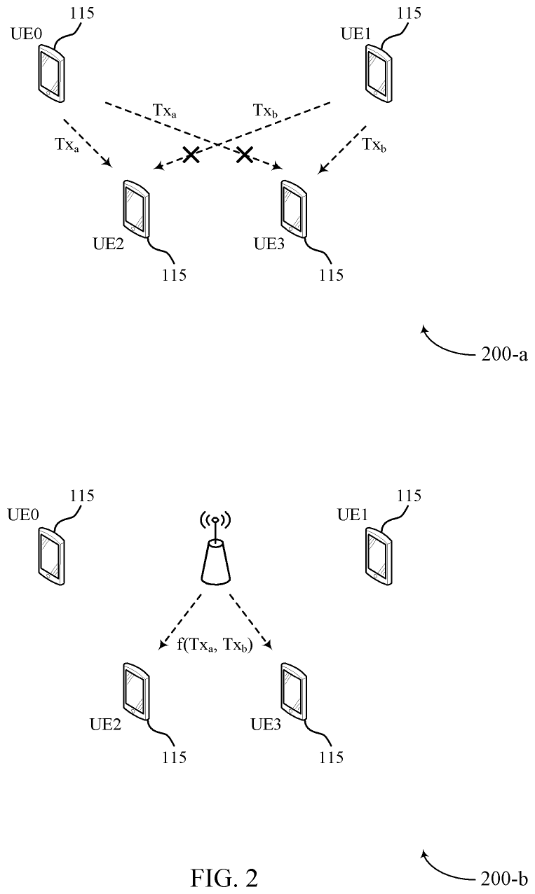

FIG. 2 illustrates an example of retransmissions 200 (e.g., retransmission 200-a and retransmission 200-b) using network coding that supports encoder selection for network coding in accordance with one or more aspects of the present disclosure. Network coding may be used to increase system capacity and improve resource utilization. The increased system capacity and improved resource utilization may be achieved by reducing the number of retransmissions in a system while maintaining performance. Network coding may enable an increase in the number of UEs 115 or traffic per UE 115. As illustrated in a first example of a retransmission 200-a, one or more source UEs 115 (e.g., UE0 and UE1) may transmit packets to one or more target UEs 115 (e.g., UE2 and UE3). Then, in a second example of a retransmission 200-b, a network coding device may retransmit the packets to the one or more target UEs 115. That is, after an initial or original transmission, retransmissions by a source transmitter may be replaced by a retransmission by a network coding device. The network coding device may be a network entity 105, an RSU, or a UE 115.

In one example of network coding, single parity check codes may correct one erasure of a packet. For instance, an input of [a, b, c] may be encoded to [a, b, c, a⊕b⊕c] and then transmitted, where a, b, and c each correspond to different packets. A receiving device may then recover one erasure from the network coded transmission. In particular, if the received vector is [a, ?, c, a⊕b⊕c], the erased element (e.g., b) may be recovered by summing the other elements (e.g., a⊕c⊕(a(b(c)=b). Network coding may be viewed as a linear system (e.g., over a Galois field) with three variables and four linearly independent constraints in accordance with Equation 1, below. Any three constraints (e.g., one erasure) may be sufficient to find the three variables. A single network coded transmission or encoded sequence from a network coding device may therefore replace multiple retransmissions or encoded sequences from multiple wireless devices.

$$[ \begin{matrix}1 & 0 & 0 \\ 0 & 1 & 0 \\ 0 & 0 & 1 \\ 1 & 1 & 1\end{matrix} ] \cdot {[ \begin{matrix}a & b & c\end{matrix} ]}^{T} = {[ \begin{matrix}a & b & c & a ⊕ b ⊕ c\end{matrix} ]}^{T} \qquad ( 1 )$$

In some wireless communications systems, the network coding device may be selected by a central entity (e.g., central controller, central network entity, central base station, central gNodeB) as not all available devices may be suitable for serving as a network coding device. However, while some other wireless communications systems (e.g., implementing mode 2 operations) may support retransmissions 200 using network coding, in such examples there may not be a central entity that is assigned or configured to perform encoder selection. In such examples, a UE 115 may identify suitable network coding device and may perform encoder selection.

As described herein, the UE 115 may initiate a network coding device selection procedure by transmitting an announcement message to one or more wireless devices (e.g., RSU, network entities 105, UEs 115, or the like), where the announcement message includes a request for at least one device to serve as a network coding device (e.g., an encoder). The announcement message may indicate a quantity of network encoders requested, as well as one or more thresholds that a suitable network encoder may satisfy. In some examples, the thresholds may include a speed threshold of the network coding device, a remaining power threshold of the network coding device, an available buffer size threshold of the network coding device, an available computation task threshold of the network coding device, one or more reference signal received power (RSRP) thresholds of the network coding device, or the like.

In response to the announcement message, the UE 115 may receive one or more confirmation messages that indicate at least one other device that may serve as a network coding device. For example, each confirmation message may include a vote for a particular device to serve as the network coding device. In such cases, each vote may nominate the device to serve as the network coding device. Further, each vote may indicate a device ID for the particular device associated with the vote. In some cases, a device submitting a vote via the confirmation message may vote for itself (e.g., as a default). The UE 115 may determine a quantity of votes for (e.g., nominating) each device based on the received confirmation messages, and the device(s) with the greatest quantity of votes may be selected by the UE 115 as a network coding device.

Additionally, or alternatively, a confirmation message may include an indication (e.g., a claim) that some device will serve as the network coding device, which, in some examples, may prohibit one or more other devices from serving as the network coding device. In such cases, the claim may be transmitted after a random backoff time or after a time period based on some parameters associated with the device transmitting the claim (e.g., which may provide some priority to devices currently serving as a network coding device). The UE 115 may select a network coding device based on the one or more received claims and based on the network coding device satisfying the one or more thresholds.

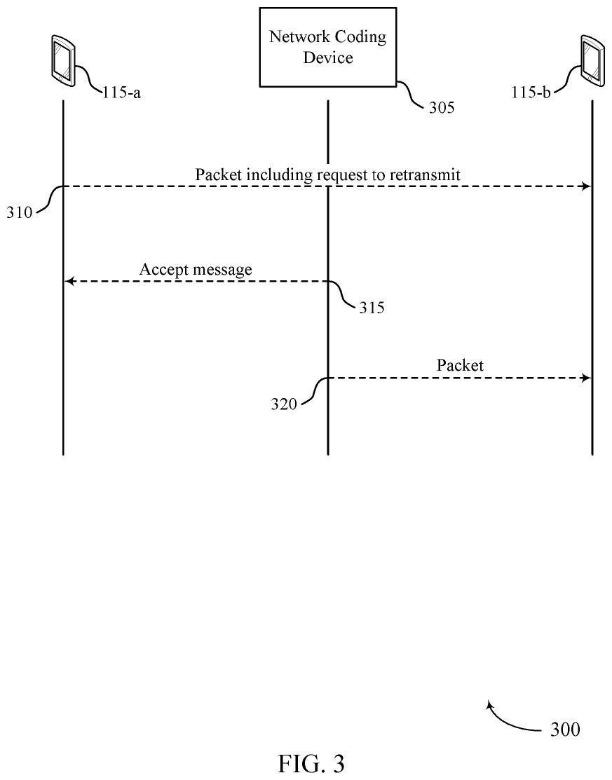

FIG. 3 illustrates an example of a process flow 300 in a system that supports encoder selection for network coding in accordance with one or more aspects of the present disclosure. The process flow 300 may be an example protocol using network coding for sidelink communication. The process flow 300 includes a UE 115-a and a UE 115-b, which may be examples of UEs 115 described with reference to FIGS. 1 and 2. The process flow 300 also includes a network coding device 305, which may be an example of a network coding device described with reference to FIGS. 1 and 2. The network coding device 305 may be an RSU, relay device, UE 115, or a network entity 105. At 310, the UE 115-a (e.g., a source UE 115) may transmit a packet or transport block with a network coding request flag (e.g., a network coding request message). At 315, the network coding device 305 may transmit an accept message to the UE 115-a to accept the request (e.g., the request to retransmit the packet). That is, the network coding device 305 may send a message to accept the request to include the packet as part of a network coded transmission. At 320, the network coding device 305 may then transmit the packet in a network coded transmission to the UE 115-b.

In some cases, (e.g., distributed network coding) there may be one or multiple devices identified as being capable of serving as network encoders in an area. However, not all of the devices may be suitable for serving as network encoders (e.g., network coding devices). Thus, a suitable network coding device may be selected by a network entity 105 or a central controller. In some cases (e.g., mode 2 communications), however, there may not be a network entity 105 or central controller to perform the network coding device selection. As a result, the UE 115-a (or other device, for example) may initiate network coding device selection by transmitting an announcement message (e.g., using PSCCH). Process flow 300 may support a procedure for coding device selection performed by a UE 115-a (or other device) via an announcement message that may indicate a number of encoders requested from the UE 115-a and one or more thresholds for identifying a suitable network coding device. In some cases, the announcement message may be included in or be an example of the network coding request message (e.g., at 315). The UE 115-a may select a suitable network coding device based on responses to the announcement message and transmit a second announcement message to one or more devices (e.g., to the “winners”) indicating the selection. Based on receiving the second announcement message, a selected device that is capable of serving as a network coding device may transmit a confirmation message to the UE 115-a (e.g., confirming the receiving device is to serve as the network coding device).

The described techniques may enhance network coding procedures and minimize signaling overhead. For instance, the described techniques may minimize signaling between network encoders by enabling network encoding in some wireless communications systems (e.g., wireless communications system implementing sidelink mode 2 communications) in which a central controller is not configured, among other examples, thus providing at least some similar advantages as those experienced in wireless communications systems implementing a central controller. Such techniques may be used in some area or geographic location, or among a group of moving vehicles (e.g., two or more vehicle UEs 115 in a vehicle platooning system (which may be referred to as flocking)), or both.

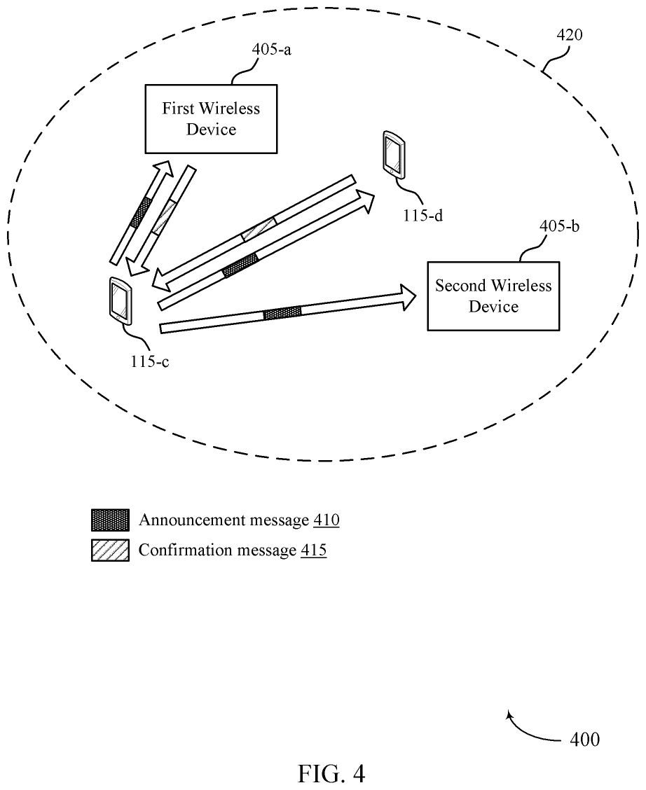

FIG. 4 illustrates an example of a wireless communications system 400 that supports encoder selection for network coding in accordance with one or more aspects of the present disclosure. The wireless communications system 400 includes a first UE 115-c and a second UE 115-d, which may be examples of the UEs 115 described with reference to FIGS. 1-3. The wireless communications system 400 also includes a first wireless device 405-a and a second wireless device 405-b, which may be examples of wireless devices described with reference to FIGS. 1-3 (e.g., UE 115, RSUs, relay devices, network entities 105). The wireless communications system 400 may implement aspects of the wireless communications system 100, the retransmissions 200, and the process flow 300. For example, the wireless communications system 400 may support efficient techniques for network coding device selection.

The first UE 115-c may initiate an encoder selection process by transmitting an announcement message 410 to one or more of the first wireless device 405-a, the second wireless device 405-b, or the second UE 115-d. The announcement message may be transmitted via PSCCH. The announcement message may include a quantity of fields for identifying a suitable network coding device and, in some examples, may include a network coding request. For example, the announcement message may indicate one or more of a number of network coding devices (e.g., network encoders) requested by the first UE 115-c, a speed threshold of the receiving device (e.g., first wireless device 405-a, second wireless device 405-b, or second UE 115-d), a remaining power threshold of the receiving device, an available buffer size threshold, an available computation task load threshold, an indication of one or more RSRP statistics to be satisfied (e.g., a threshold of the average RSRP for all other receiving devices), or any combination thereof. The various thresholds may be used to ensure that a possible network coding device is available and has a capability to perform retransmissions of the packets transmitted by the first UE 115-c. For instance, the available computation task load threshold may ensure that a potential network coding device is able to handle a load of packet retransmissions on behalf of the first UE 115-c. The fields of the announcement message may be preconfigured at the first UE 115-c or may be dynamically configured by a network entity (e.g., network entity 105 as described with reference to FIG. 1). Devices that satisfy the indicated thresholds of the announcement message may be identified as suitable network coding devices.

In some examples, the first UE 115-c may monitor for network coding devices and may transmit the announcement message 410 based on determining there is no network coding device serving the area 420. For example, the first UE 115-c may transmit the announcement message 410 based on determining that a wireless device has ceased operation as a network coding device or based on determining that the serving network coding device left the area 420, among other examples.

The first UE 115-c may transmit a quantity, n, of messages for network encoding (e.g., network coding request messages). However, if there is no serving network encoder, the first UE 115-c may determine an absence of messages accepting the n most recent network coding request messages sent by the first UE 115-c. The first UE 115-c may initiate the selection procedure by transmitting the announcement message 410 based on the absence. In some examples, n may be preconfigured. In other examples, n may be configured by a network entity 105 and signaled to the first UE 115-c.

In some other examples, the first UE 115-c may determine an absence of network coding packets or encoder-claiming packets, or both (e.g., from other devices) for a time duration, W, and may initiate the selection procedure by transmitting the announcement message 410 based on the absence of the packets. The time duration, W, may be preconfigured or may be configured (e.g., dynamically) by a network entity 105 and signaled to the first UE 115-c.

In some examples, the first UE 115-c may receive an announcement message from one or more other UE 115 during a time duration, T, and may refrain from transmitting the announcement message 410. Here, if other UE 115 are initiating a network coding device selection procedure, the first UE 115-c may refrain from beginning its own network coding device selection procedure. The time duration, T, may be preconfigured or may be configured (e.g., dynamically) by a network entity 105 and signaled to the first UE 115-c.

In some examples, the first UE 115-c may receive signaling from one or more existing network coding devices in the area 420. The signaling may indicate to the first UE 115-c that the one or more existing network coding devices are serving as a network coding device.

Based on receiving the announcement message 410, one or more of the first wireless device 405-a, the second wireless device 405-b, or the second UE 115-d may transmit a confirmation message 415 to the first UE 115-c (e.g., the source UE). In some examples, the confirmation message may be transmitted via PSCCH. For example, the confirmation message may include a vote for (e.g., nominating) at least one wireless device. For example, the first wireless device 405-a may transmit the confirmation message 415 that includes a vote for the second wireless device 405-b to serve as the network coding device. In other examples, the first wireless device 405-a may transmit the confirmation message 415 that includes a vote for itself to serve as the network coding device. In some aspects, a device may vote for itself by default (e.g., if no other devices are present or no other device may be suitable to serve as a network coding device). The vote may include a device ID, a weighting factor of the device (e.g., computed based on one or more characteristics of the device (e.g., RSRP, traffic load)), a ballot indication (e.g., one or more bits indicating that the confirmation message is for a ballot, indicating that the confirmation message includes a vote cast for a device). In some examples, a receiving device may transmit multiple ballots. For example, the receiving device may transmit a ballot representing itself, a ballot representing another device, or both.

The first UE 115-c may collect ballots during a time duration, W2, and may transmit a second announcement message (e.g., via PSCCH, MAC-CE, or other signaling) indicating one or multiple selected network coding devices. For instance, one or more devices may have multiple votes, and the device(s) that have the greatest quantity of votes may be selected as the “winning” network coding devices. In some aspects, the time duration, W2, may be preconfigured or may be dynamically configured by a network entity 105 and signaled to the first UE 115-c.

An example second announcement may include a device ID for each selected device or one or more bits to indicate the announcement is a winner announcement, or both. In some examples, two devices may be equally suitable for serving as a network coding device or may have received a same quantity of votes, however, both devices may not be needed by the first UE 115-c for network encoding and, as such, a random selection may be performed by the first UE 115-c in the case of a tie. The selected one or more network coding devices may respond to the second announcement by transmitting (e.g., unicasting or broadcasting) a second confirmation message indicating the selected device accepts the role of serving as a network coding device.

In some examples, no devices may accept the role, or not enough devices may accept the role (e.g., based on the requested quantity of network coding devices). In such cases, a quantity of received second confirmation messages may fail to satisfy a threshold quantity of confirmation messages, where the threshold may be preconfigured or may be dynamically configured by a network entity. In some examples, the first UE 115-c may transmit an additional second announcement message indicating a list of newly-selected devices (e.g., back-up network coding devices), which may be based on the initial set of selected network coding devices and/or the collected votes. The additional second announcement may have a same format as the second announcement. In some examples, the additional second announcement message may be based on a list of selected devices retained at the first UE 115-c or based on initiating a new selection process. That is, the first UE 115-c may transmit a second announcement message that includes a modified list of network coding devices selected by the first UE 115-c. In some examples, the first UE 115-c may store a set of selected network coding devices.

Based on receiving the announcement message 410, one or more of the first wireless device 405-a, the second wireless device 405-b, or the second UE 115-d may transmit, to the first UE 115-c (e.g., the source UE), a confirmation message 415 including a claim for the transmitting wireless device or another wireless device to be the network coding device. The confirmation message 415 may be transmitted after a back off time, T. In some such examples, the confirmation message 415 may include a claim indication (e.g., one or more bits indicating that the confirmation message 415 includes a claim) or a device ID (e.g., a device ID of the transmitting device, a device ID of another device on behalf of which the transmitting device is claiming network encoder status), or both. The confirmation message may be transmitted via a control channel (e.g., PSCCH, PDCCH).

In some examples, the backoff time (e.g., a slot duration), T, may be randomly chosen or generated. For example, the backoff time, T, may be chosen (e.g., randomly chosen) by the first UE 115-c from a range of backoff times. In some examples, the range of backoff times may be preconfigured or may be signaled (e.g., dynamically) by a network entity 105 and signaled to the first UE 115-c.

The confirmation message 415 transmitted based on the randomly selected or generated backoff time, T, may block or preclude other devices from claiming the role of network coding device based on the first UE 115-c receiving confirmation messages 415 from the number of requested network coding devices. For example, the first UE 115-c may request two network coding devices via the announcement message 410. Based on receiving the announcement, first wireless device 405-a and second UE 115-d may each transmit a confirmation message 415 after a random backoff time, T including a claim for the first wireless device 405-a and the second UE 115-d, respectively, to serve as the two requested network coding devices. As such, the second wireless device 405-b may be blocked or precluded from claiming the role of network coding device.

The backoff time, T, may vary based on device that transmits the confirmation message 415. For example, if one of the first wireless device 405-a or the UE 115-a is an existing network coding device, then T may be a relatively small value for devices operating as a network coding device (e.g., compared to devices that are not operating as network coding devices). As an example, an existing network coding device (e.g., a network coding device that is currently serving as a network coding device for one or more other UEs 115) may use a value of T=1 for the backoff time. In some cases, varying the duration of the backoff time, T, may bias the likelihood that a device currently operating as a network coding device will remain operating as a network coding device, which may provide efficiency for selecting a network coding device. In some aspects, the first UE 115-c may transmit a second announcement indicating the selected network coding devices based on the claim(s) received via the confirmation message(s) 415.

In some examples, based on receiving the announcement message 410, one or more of the first wireless device 405-a, the second wireless device 405-b, or the second UE 115-d may transmit, to the first UE 115-c (e.g., source UE), a confirmation message 415 including a claim for the transmitting wireless device or another wireless device to be the network coding device. The confirmation message 415 may be transmitted after a backoff time, T. In some such examples, the confirmation message 415 may include a claim indication or a device ID (e.g., a device ID of the transmitting device, a device ID of another device on behalf of which the transmitting device is claiming network encoder status), or both. The confirmation message may be transmitted via a control channel (e.g., PSCCH, PUCCH).

In some examples, the backoff time (e.g., a duration of one or more slots, symbols, or the like), T, may be calculated based on a set of factors. For example, the backoff time, T, may be calculated using Equation 2, below.

$$T = floor ( \frac{P}{score \times slot duration} ) \qquad ( 2 )$$

In some examples, the score parameter in Equation 2 may be determined based on a weighted sum of thresholds, variables, fields, or any combination thereof, indicated in the announcement message. In such cases, qualified devices may be associated with and compute a relatively higher score parameter, resulting in the backoff time T for the device to be relatively shorter in accordance with Equation 2, thereby increasing the likelihood that a qualified device will serve as the network coding device. The parameter, P, may be preconfigured or signaled (e.g., dynamically) by a network entity. The confirmation message 415 transmitted based on the calculated backoff time, T may block or preclude other devices from claiming the role of network coding device based on the first UE 115-c receiving confirmation messages 415 from the number of requested network coding devices.

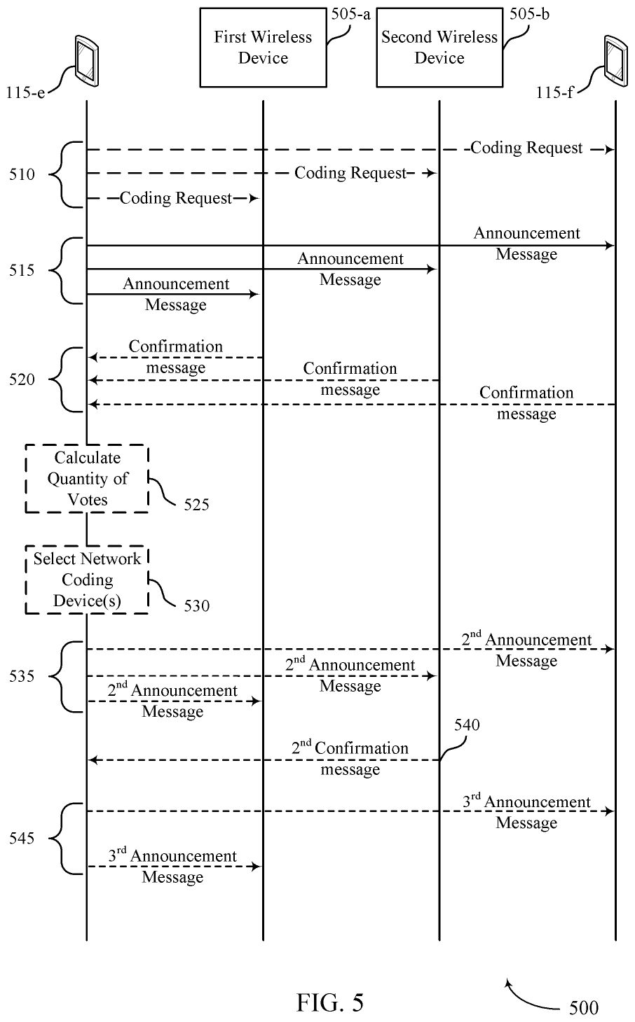

FIG. 5 illustrates an example of a process flow 500 in a system that supports encoder selection for network coding in accordance with one or more aspects of the present disclosure. The process flow 500 includes a UE 115-e and a UE 115-f, which may be examples of UEs 115 described with reference to FIGS. 1-4. The process flow 500 also includes a first wireless device 505-a and a second wireless device 505-b, which may be examples of wireless devices described with reference to FIGS. 1-4 (e.g., UE 115, RSUs, relay devices, network entities 105). The process flow 500 may implement aspects of the wireless communications system 100 or 400, or both. For instance, the process flow 500 may support efficient techniques for network coding device selection.

In the following description of the process flow 500, the signaling exchanged between the UE 115-e, the UE 115-f, the first wireless device 505-a, and the second wireless device 505-b may be exchanged in a different order than the example order shown, or the operations performed by the UE 115-e, the UE 115-f, the first wireless device 505-a, and the second wireless device 505-b may be performed in different orders or at different times. Some operations may also be omitted from the process flow 500, and other operations may be added to the process flow 500.

At 510, the UE 115-e may transmit a quantity of network coding request messages to one or more of the first wireless device 505-a, the second wireless device 505-b, the UE 115-f, or any combination thereof. The network coding request may include a request by the UE 115-e for a network coding device to retransmit one or more packets originally transmitted by the UE 115-e. In some examples, the network coding requests may further include the packets for retransmission.

At 515, the UE 115-e may transmit, to one or more of the first wireless device 505-a, the second wireless device 505-b, the UE 115-f, or any combination thereof, an announcement message including a request for at least one of the receiving devices to serve as a network coding device. Additionally, or alternatively, the announcement message may include a network coding request message including a request for retransmitting the packets originally transmitted from the UE 115-e. In some examples, the announcement message transmissions may be triggered by an absence of one or more acceptance messages in response to the quantity of network coding request messages (e.g., transmitted at 510). In some examples, the announcement message transmissions may be triggered by an absence of network coding packets, or encoder claiming packets, or both, in a duration of time. For instance, the UE 115-e may determine that one or more network coding packets (e.g., one or more transmissions of transport blocks having a network coding request flag, one or more packets transmitted from a network coding device for network coding transmissions (e.g., retransmissions)) have not been received within the duration of time. Additionally, or alternatively, the UE 115-e may determine that one or more encoder claiming packets (e.g., accept request packets, messages accepting a request for retransmissions of a transport block as part of a network coded transmission) have not been received within the duration of time. The duration of time may be preconfigured, signaled to the UE 115-e by a network entity, or any combination thereof.

The announcement message may include a number of requested network coding devices or one or more criteria for determining whether a device is qualified to serve as a network coding device, or both. The one or more criteria may include a speed threshold, a remaining power threshold, an available buffer size threshold, a computational load threshold, a reference signal received power threshold, or any combination thereof.

At 520, the UE 115-e may receive one or more confirmation messages from one or more of the first wireless device 505-a, the second wireless device 505-b, the UE 115-f, or any combination thereof, in response to the announcement message. In some examples, each received confirmation message may indicate that the device that transmitted the confirmation message, or another device identified by the device transmitting the confirmation message and that is capable of serving as the network coding device, or both.

In some examples, at 520, the UE 115-e may receive a first confirmation message from one of the first wireless device 505-a, the second wireless device 505-b, the UE 115-f, or any combination thereof after a backoff time. The first confirmation message may indicate (e.g., via a claim) that the transmitting device or another device will serve as the network coding device and may preclude other wireless devices from serving as the network coding device beyond a number of request network coding devices. The first confirmation message may include an indication that the at least one confirmation message is associated with a claim for the transmitting device or another device to be the network coding device and an identifier of the indicated device.

The backoff time may include a time duration that is randomly selected from a range of time durations or the backoff time may include a time duration that is calculated by the transmitting device (e.g., the first wireless device 505-a, the second wireless device 505-b, the UE 115-f) based on a parameter, a score, and a slot duration. Further, the score may be based on a sum (e.g., a weighted sum) of criteria indicated by the announcement message for which the indicated device satisfies. In some examples, the backoff time may be equal to a predefined (e.g., preconfigured) value based on the transmitting device (e.g., the first wireless device 505-a, the second wireless device 505-b, the UE 115-f) serving as an existing network coding device

Additionally, or alternatively, at 520, each confirmation message of the one or more received confirmation messages may include a vote nominating the transmitting wireless device or another wireless device to serve as the network coding device and, at 525, the UE 115-e may calculate or tally the votes nominating each respective wireless device indicated via the one or more confirmation messages. Each confirmation message may include an identifier of a wireless device, a weighted value of a wireless device, an indication that the confirmation message includes a vote, or any combination thereof.

In some examples, at 525, the UE 115-e, may calculate that a first device and a second device of the first wireless device 505-a, the second wireless device 505-b, the UE 115-f have a same quantity of votes (e.g., are tied) and at 530, may randomly select one of the tied devices to serve as the network coding device. In other examples, the UE 115-e may identify the device(s) that have a largest quantity of votes based on the confirmation messages received at 520. The network coding device may be selected in accordance with the calculated quantity of votes nominating each device.

In some examples, at 530, the UE 115-e may select one or more qualified network coding devices from the indicated wireless devices based on the confirmation messages received at 520. Each selected network coding device may satisfy at least one criteria indicated by the announcement message. The UE 115-e may store a list of qualified network coding devices based on selecting the one or more network coding devices.

At 535, the UE 115-e may transmit, to one or more of the first wireless device 505-a, the second wireless device 505-b, the UE 115-f, or any combination thereof, a second announcement message indicating which network coding devices that have been selected. In some examples, the second announcement message may be transmitted after a time duration for receiving confirmation messages and includes an identifier for each selected network coding device.

At 540, the UE 115-e may receive, from one or more of the first wireless device 505-a, the second wireless device 505-b, the UE 115-f, or any combination thereof, a second confirmation message in response to the second announcement message. The second confirmation message may indicate the device transmitting the second confirmation message will serve as the network coding device for retransmitting the packets originally transmitted from the UE 115-e.

In some examples, at 545, the UE 115-e may determine an absence of a second confirmation message in response to the second announcement message, and may transmit a third announcement message based on the absence of the second confirmation message. In some examples, the third announcement message may include an indication of a modified set of one or more network coding devices. Here, the third announcement message (e.g., indicating the selected network coding devices) may be transmitted to a subset of other devices based on a modified set of network coding devices (e.g., because a response was not received from the selected network devices indicated in an initial transmission of the second announcement message).

In some other examples, at 545, the UE 115-e may determine that a received quantity of second confirmation messages fails to satisfy a threshold quantity of confirmation messages, and may transmit a third announcement message based on the quantity of the second confirmation messages failing to satisfy the threshold quantity of confirmation messages. In some examples, the third announcement message may include a modified indication of which network coding devices have been selected. For example, the third announcement message may include an indication of one or more selected back-up network coding devices or may request fewer network coding devices.

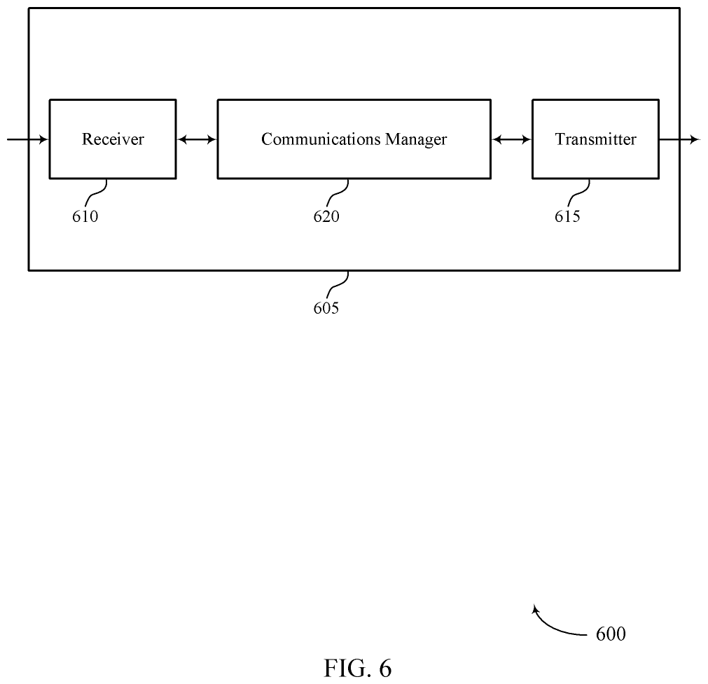

FIG. 6 shows a block diagram 600 of a device 605 that supports encoder selection for network coding in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to encoder selection for network coding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to encoder selection for network coding). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of encoder selection for network coding as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for transmitting, to one or more wireless devices, an announcement message including a request for at least one of the one or more wireless devices to serve as a network coding device for retransmitting packets originally transmitted from the UE. The communications manager 620 may be configured as or otherwise support a means for receiving one or more confirmation messages in response to the announcement message, where each confirmation message of the one or more confirmation messages indicates a wireless device that is capable of serving as the network coding device. The communications manager 620 may be configured as or otherwise support a means for selecting a set of one or more network coding devices from the one or more wireless devices based on the one or more confirmation messages.

Additionally, or alternatively, the communications manager 620 may support wireless communication at a wireless device in accordance with examples as disclosed herein. For example, the communications manager 620 may be configured as or otherwise support a means for receiving, from a UE, an announcement message including a request for at least one wireless device to serve as a network coding device for retransmitting packets originally transmitted from the UE. The communications manager 620 may be configured as or otherwise support a means for transmitting, to the UE, a confirmation message in response to the announcement message, where the confirmation message indicates that the wireless device or another wireless device is capable of serving as the network coding device.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources, among other examples.

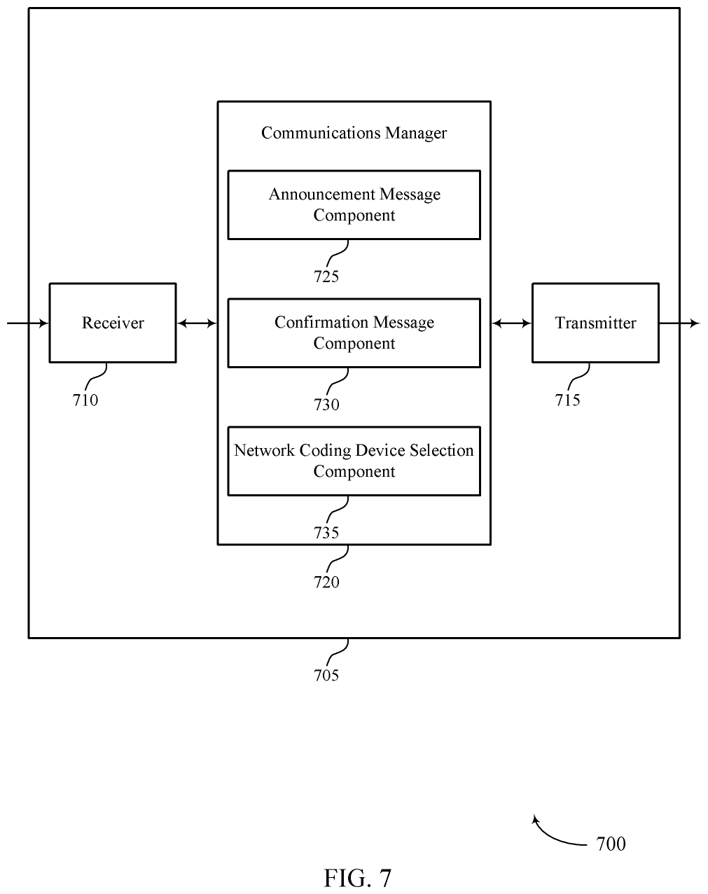

FIG. 7 shows a block diagram 700 of a device 705 that supports encoder selection for network coding in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to encoder selection for network coding). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to encoder selection for network coding). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of encoder selection for network coding as described herein. For example, the communications manager 720 may include an announcement message component 725, a confirmation message component 730, a network coding device selection component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The announcement message component 725 may be configured as or otherwise support a means for transmitting, to one or more wireless devices, an announcement message including a request for at least one of the one or more wireless devices to serve as a network coding device for retransmitting packets originally transmitted from the UE. The confirmation message component 730 may be configured as or otherwise support a means for receiving one or more confirmation messages in response to the announcement message, where each confirmation message of the one or more confirmation messages indicates a wireless device that is capable of serving as the network coding device. The network coding device selection component 735 may be configured as or otherwise support a means for selecting a set of one or more network coding devices from the one or more wireless devices based on the one or more confirmation messages.

Additionally, or alternatively, the communications manager 720 may support wireless communication at a wireless device in accordance with examples as disclosed herein. The announcement message component 725 may be configured as or otherwise support a means for receiving, from a UE, an announcement message including a request for at least one wireless device to serve as a network coding device for retransmitting packets originally transmitted from the UE. The confirmation message component 730 may be configured as or otherwise support a means for transmitting, to the UE, a confirmation message in response to the announcement message, where the confirmation message indicates that the wireless device or another wireless device is capable of serving as the network coding device.

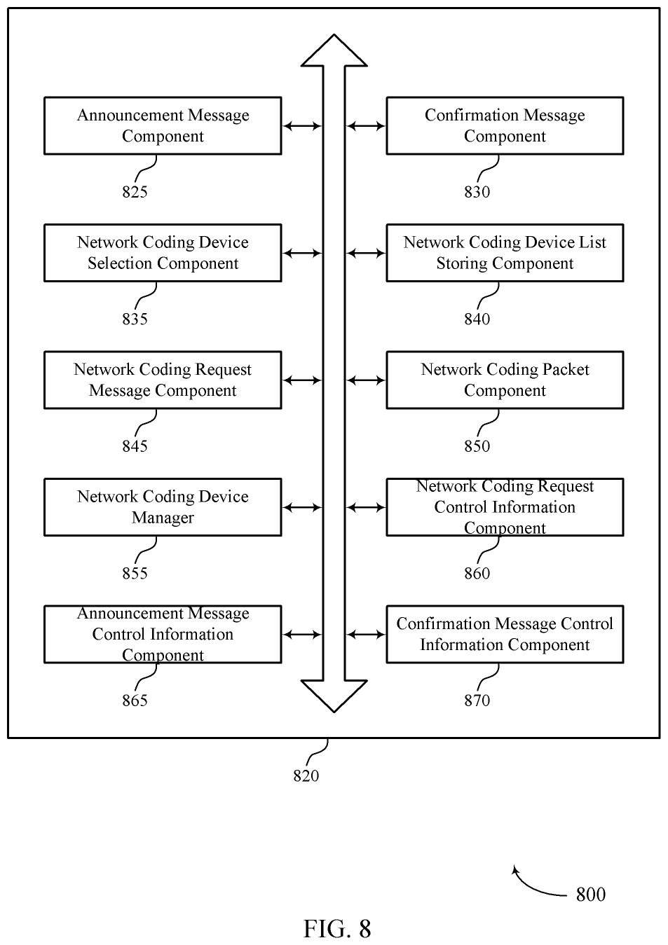

FIG. 8 shows a block diagram 800 of a communications manager 820 that supports encoder selection for network coding in accordance with one or more aspects of the present disclosure. The communications manager 820 may be an example of aspects of a communications manager 620, a communications manager 720, or both, as described herein. The communications manager 820, or various components thereof, may be an example of means for performing various aspects of encoder selection for network coding as described herein. For example, the communications manager 820 may include an announcement message component 825, a confirmation message component 830, a network coding device selection component 835, a network coding device list storing component 840, a network coding request message component 845, a network coding packet component 850, a network coding device manager 855, a network coding request control information component 860, an announcement message control information component 865, a confirmation message control information component 870, or any combination thereof. Each of these components may communicate, directly or indirectly, with one another (e.g., via one or more buses).

The communications manager 820 may support wireless communication at a UE in accordance with examples as disclosed herein. The announcement message component 825 may be configured as or otherwise support a means for transmitting, to one or more wireless devices, an announcement message including a request for at least one of the one or more wireless devices to serve as a network coding device for retransmitting packets originally transmitted from the UE. The confirmation message component 830 may be configured as or otherwise support a means for receiving one or more confirmation messages in response to the announcement message, where each confirmation message of the one or more confirmation messages indicates a wireless device that is capable of serving as the network coding device. The network coding device selection component 835 may be configured as or otherwise support a means for selecting a set of one or more network coding devices from the one or more wireless devices based on the one or more confirmation messages.

In some examples, each confirmation message of the one or more confirmation messages includes a vote nominating the wireless device to serve as the network coding device, and the confirmation message component 830 may be configured as or otherwise support a means for calculating, by the UE, a quantity of votes nominating respective wireless devices indicated via the one or more confirmation messages, where the set of one or more network coding devices is selected based on the quantity of votes nominating each of the respective wireless devices.

In some examples, to support selecting the set of one or more network coding devices, the confirmation message component 830 may be configured as or otherwise support a means for calculating, by the UE, that a first wireless device and a second wireless device of the one or more wireless devices have a same quantity of votes based on the one or more confirmation messages. In some examples, to support selecting the set of one or more network coding devices, the network coding device selection component 835 may be configured as or otherwise support a means for randomly selecting the first wireless device or the second wireless device in the set of one or more network coding devices based on the calculation.

In some examples, each confirmation message further includes an identifier of the wireless device, a weighted value of the wireless device, an indication that the confirmation message includes the vote, or any combination thereof.

In some examples, the one or more confirmation messages are received during a first time duration, and the announcement message component 825 may be configured as or otherwise support a means for transmitting, to the set of one or more network coding devices, a second announcement message indicating that the set of one or more network coding devices has been selected, where the second announcement message is transmitted after the first time duration.

In some examples, the second announcement message includes an identifier for each network coding device of the set of one or more network coding devices.

In some examples, the confirmation message component 830 may be configured as or otherwise support a means for receiving, from at least one network coding device of the set of one or more network coding devices, a second confirmation message in response to the second announcement message, the second confirmation message indicating that the at least one network coding device will serve as the network coding device for retransmitting the packets originally transmitted from the UE.

In some examples, the confirmation message component 830 may be configured as or otherwise support a means for determining an absence of a second confirmation message received from at least one network coding device of the set of one or more network coding devices in response to the second announcement message. In some examples, the announcement message component 825 may be configured as or otherwise support a means for transmitting a third announcement message based on the absence of the second confirmation message, the third announcement message including an indication of a modified set of one or more network coding devices.

In some examples, the confirmation message component 830 may be configured as or otherwise support a means for determining that a quantity of second confirmation messages from the set of one or more network coding devices fails to satisfy a threshold quantity of confirmation messages. In some examples, the announcement message component 825 may be configured as or otherwise support a means for transmitting a third announcement message based on the quantity of the second confirmation messages failing to satisfy the threshold quantity of confirmation messages, the third announcement message including an indication of a modified set of one or more network coding devices.

In some examples, to support receiving the one or more confirmation messages, the confirmation message component 830 may be configured as or otherwise support a means for receiving a first confirmation message from at least one wireless device after a backoff time, the first confirmation message indicating that the at least one wireless device will serve as the network coding device, where the at least one wireless device is selected for the set of one or more network coding devices based on the first confirmation message.

In some examples, the announcement message component 825 may be configured as or otherwise support a means for transmitting a second announcement message indicating that the set of one or more network coding devices has been selected based on receiving the first confirmation message.

In some examples, the first confirmation message includes an indication that the first confirmation message is associated with a claim for the at least one wireless device to be the network coding device and an identifier of the at least one wireless device.

In some examples, the first confirmation message precludes other wireless devices from serving as the network coding device.

In some examples, the backoff time includes a time duration randomly selected from a range of time durations.

In some examples, the backoff time includes a time duration that is calculated based on a parameter, a score, and a slot duration.

In some examples, the score is based on a weighted sum of criteria indicated via the announcement message for which the at least one wireless device satisfies.

In some examples, the network coding device list storing component 840 may be configured as or otherwise support a means for storing a list of the set of one or more network coding devices based on selecting the set of one or more network coding devices.

In some examples, the network coding request message component 845 may be configured as or otherwise support a means for transmitting a quantity of network coding request messages to one or more network coding devices, where transmitting the announcement message is triggered via an absence of one or more acceptance messages in response to the quantity of network coding request messages.

In some examples, the network coding request control information component 860 may be configured as or otherwise support a means for receiving, from a network entity, a message including an indication of the quantity of network coding request messages.

In some examples, the quantity of network coding request messages is preconfigured.

In some examples, the network coding packet component 850 may be configured as or otherwise support a means for determining an absence of network coding packets, or encoder claiming packets, or both, for a second time duration, where transmitting the announcement message is triggered via the absence of the network coding packets, or the encoder claiming packets, or both, for the second time duration.

In some examples, the network coding packet component 850 may be configured as or otherwise support a means for receiving, from a network entity, a message including an indication of the second time duration.

In some examples, the second time duration is preconfigured.

In some examples, the announcement message component 825 may be configured as or otherwise support a means for receiving one or more announcement messages from one or more other UEs during a third time duration. In some examples, the announcement message component 825 may be configured as or otherwise support a means for refraining from transmitting a second announcement message based on the one or more announcement messages received during the third time duration.

In some examples, the announcement message control information component 865 may be configured as or otherwise support a means for receiving, from a network entity, a message indicating the third time duration.

In some examples, the third time duration is preconfigured.

In some examples, the network coding device manager 855 may be configured as or otherwise support a means for receiving, from at least one network coding device and in response to the announcement message, a message indicating that the at least one network coding device serves as an existing network coding device.

In some examples, the network coding device manager 855 may be configured as or otherwise support a means for monitoring for one or more existing network coding devices. In some examples, the network coding device manager 855 may be configured as or otherwise support a means for determining an absence of an existing network coding device based on the monitoring, where transmitting the announcement message is based on determining the absence of the existing network coding device.

In some examples, to support determining the absence, the network coding device manager 855 may be configured as or otherwise support a means for determining that a first network coding device ceases operation as the existing network coding device.

In some examples, each network coding device of the set of one or more network coding devices satisfy one or more criteria indicated via the announcement message.

In some examples, the one or more criteria include a speed threshold, a remaining power threshold, an available buffer size threshold, a computational load threshold, a reference signal received power threshold, or any combination thereof.

In some examples, the one or more criteria are configured with a network device or preconfigured.

In some examples, the announcement message includes an indication of a quantity of network coding devices requested from the UE. In some examples, selecting the set of one or more network coding devices is based on the quantity of network coding devices requested from the UE.

In some examples, the announcement message includes an indication that the announcement message is associated with a beginning of a network coding device selection procedure at the UE.

In some examples, the announcement message includes a network coding request message including a request for retransmitting the packets originally transmitted from the UE.

Additionally, or alternatively, the communications manager 820 may support wireless communication at a wireless device in accordance with examples as disclosed herein. In some examples, the announcement message component 825 may be configured as or otherwise support a means for receiving, from a UE, an announcement message including a request for at least one wireless device to serve as a network coding device for retransmitting packets originally transmitted from the UE. In some examples, the confirmation message component 830 may be configured as or otherwise support a means for transmitting, to the UE, a confirmation message in response to the announcement message, where the confirmation message indicates that the wireless device or another wireless device is capable of serving as the network coding device.

In some examples, the confirmation message includes a vote nominating the wireless device or the other wireless device to serve as the network coding device.

In some examples, the confirmation message includes the vote nominating the wireless device based on an unavailability of one or more other wireless devices to serve as the network coding device.

In some examples, the confirmation message further includes an identifier of the wireless device, a weighted value of the wireless device, an identifier of the other wireless device, a weighted value of the other wireless device, an indication that the confirmation message includes the vote, or any combination thereof.

In some examples, the announcement message component 825 may be configured as or otherwise support a means for receiving, from the UE, a second announcement message indicating that a set of one or more network coding devices has been selected, where the second announcement message is transmitted after a first time duration for selecting network coding devices.

In some examples, the wireless device is included in the set of one or more network coding devices for the UE, and the confirmation message component 830 may be configured as or otherwise support a means for transmitting, to the UE, a second confirmation message in response to the second announcement message, the second confirmation message indicating that the wireless device will serve as the network coding device for retransmitting the packets originally transmitted from the UE.

In some examples, the second announcement message includes an identifier for each network coding device of the set of one or more network coding devices.

In some examples, to support transmitting the confirmation message, the confirmation message component 830 may be configured as or otherwise support a means for transmitting the confirmation message after a backoff time, the confirmation message indicating that the wireless device will serve as the network coding device, where the wireless device serves as the network coding device for the UE based on the confirmation message.

In some examples, the confirmation message includes an indication that the confirmation message is associated with a claim for the wireless device to be the network coding device and an identifier of the wireless device.

In some examples, the confirmation message control information component 870 may be configured as or otherwise support a means for randomly selecting the backoff time from a range of time durations.

In some examples, the confirmation message control information component 870 may be configured as or otherwise support a means for receiving, from a network entity, a message indicating the range of time durations.

In some examples, the range of time durations is preconfigured.

In some examples, the confirmation message control information component 870 may be configured as or otherwise support a means for computing the backoff time based on a parameter, a score, and a slot duration.

In some examples, the score is based on a weighted sum of criteria indicated via the announcement message for which the wireless device satisfies.

In some examples, the parameter is configured with a network device or preconfigured.

In some examples, the backoff time is equal to a predefined value based on the wireless device serving as an existing network coding device.

In some examples, the confirmation message precludes other wireless devices from serving as the network coding device.

In some examples, the announcement message includes an indication of a quantity of network coding devices requested for the UE, a speed threshold, a remaining power threshold, an available buffer size threshold, a computational load threshold, a reference signal received power threshold, or any combination thereof.

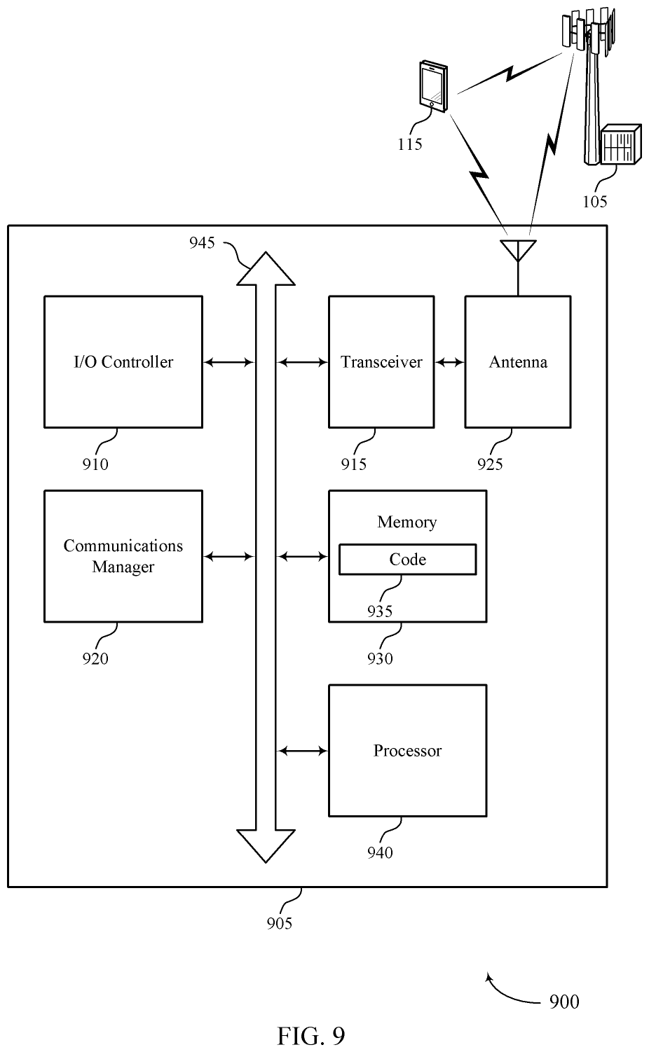

FIG. 9 shows a diagram of a system 900 including a device 905 that supports encoder selection for network coding in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting encoder selection for network coding). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for transmitting, to one or more wireless devices, an announcement message including a request for at least one of the one or more wireless devices to serve as a network coding device for retransmitting packets originally transmitted from the UE. The communications manager 920 may be configured as or otherwise support a means for receiving one or more confirmation messages in response to the announcement message, where each confirmation message of the one or more confirmation messages indicates a wireless device that is capable of serving as the network coding device. The communications manager 920 may be configured as or otherwise support a means for selecting a set of one or more network coding devices from the one or more wireless devices based on the one or more confirmation messages.

Additionally, or alternatively, the communications manager 920 may support wireless communication at a wireless device in accordance with examples as disclosed herein. For example, the communications manager 920 may be configured as or otherwise support a means for receiving, from a UE, an announcement message including a request for at least one wireless device to serve as a network coding device for retransmitting packets originally transmitted from the UE. The communications manager 920 may be configured as or otherwise support a means for transmitting, to the UE, a confirmation message in response to the announcement message, where the confirmation message indicates that the wireless device or another wireless device is capable of serving as the network coding device.

By including or configuring the communications manager 920 in accordance with examples as described herein, the device 905 may support techniques for improved communication reliability, improved user experience related to reduced processing, reduced power consumption, more efficient utilization of communication resources, improved coordination between devices, longer battery life, and improved utilization of processing capability, among other examples.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of encoder selection for network coding as described herein, or the processor 940 and the memory 930 may be otherwise configured to perform or support such operations.

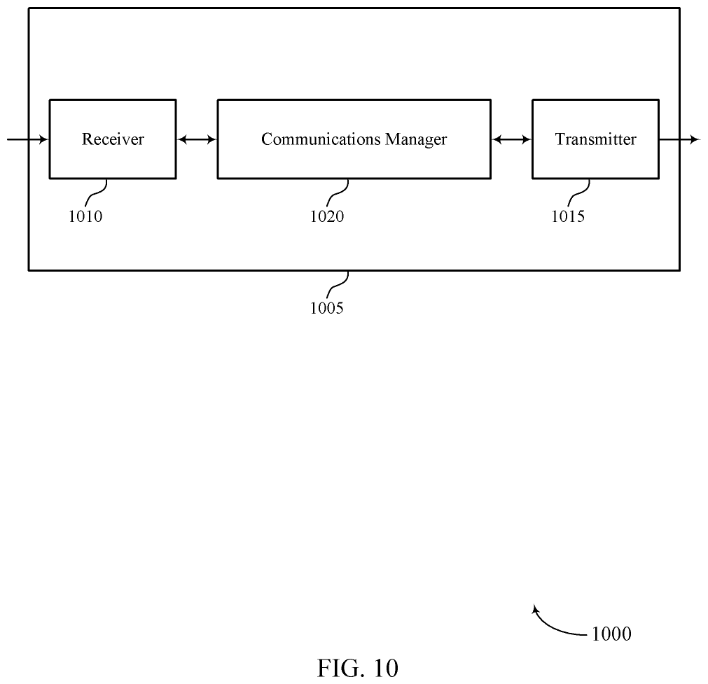

FIG. 10 shows a block diagram 1000 of a device 1005 that supports encoder selection for network coding in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of encoder selection for network coding as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a wireless device in accordance with examples as disclosed herein. For example, the communications manager 1020 may be configured as or otherwise support a means for receiving, from a UE, an announcement message including a request for at least one wireless device to serve as a network coding device for retransmitting packets originally transmitted from the UE. The communications manager 1020 may be configured as or otherwise support a means for transmitting, to the UE, a confirmation message in response to the announcement message, where the confirmation message indicates that the wireless device or another wireless device is capable of serving as the network coding device.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources, among other examples.

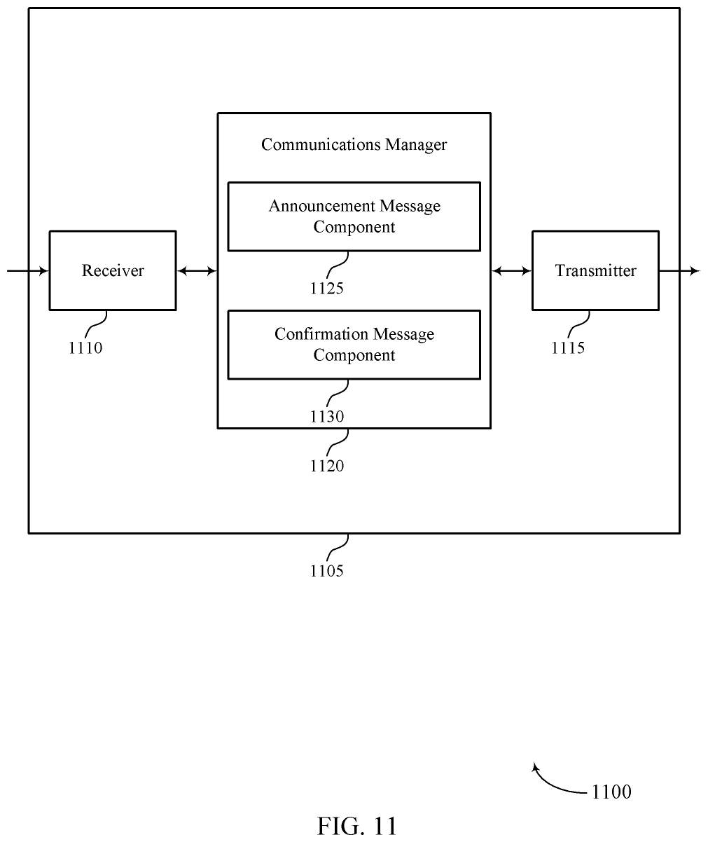

FIG. 11 shows a block diagram 1100 of a device 1105 that supports encoder selection for network coding in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of encoder selection for network coding as described herein. For example, the communications manager 1120 may include an announcement message component 1125 a confirmation message component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a wireless device in accordance with examples as disclosed herein. The announcement message component 1125 may be configured as or otherwise support a means for receiving, from a UE, an announcement message including a request for at least one wireless device to serve as a network coding device for retransmitting packets originally transmitted from the UE. The confirmation message component 1130 may be configured as or otherwise support a means for transmitting, to the UE, a confirmation message in response to the announcement message, where the confirmation message indicates that the wireless device or another wireless device is capable of serving as the network coding device.

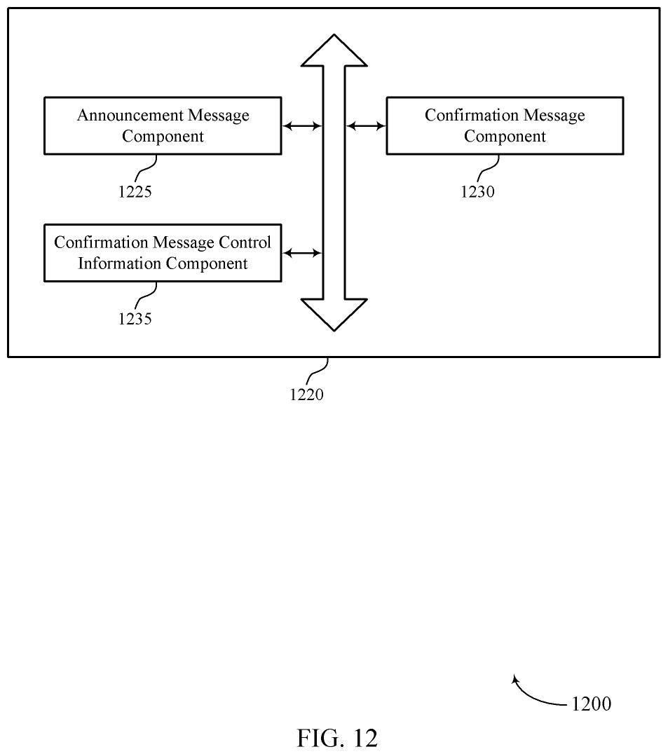

FIG. 12 shows a block diagram 1200 of a communications manager 1220 that supports encoder selection for network coding in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of encoder selection for network coding as described herein. For example, the communications manager 1220 may include an announcement message component 1225, a confirmation message component 1230, a confirmation message control information component 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a wireless device in accordance with examples as disclosed herein. The announcement message component 1225 may be configured as or otherwise support a means for receiving, from a UE, an announcement message including a request for at least one wireless device to serve as a network coding device for retransmitting packets originally transmitted from the UE. The confirmation message component 1230 may be configured as or otherwise support a means for transmitting, to the UE, a confirmation message in response to the announcement message, where the confirmation message indicates that the wireless device or another wireless device is capable of serving as the network coding device.

In some examples, the confirmation message includes a vote nominating the wireless device or the other wireless device to serve as the network coding device.

In some examples, the confirmation message includes the vote nominating the wireless device based on an unavailability of one or more other wireless devices to serve as the network coding device.

In some examples, the confirmation message further includes an identifier of the wireless device, a weighted value of the wireless device, an identifier of the other wireless device, a weighted value of the other wireless device, an indication that the confirmation message includes the vote, or any combination thereof.

In some examples, the announcement message component 1225 may be configured as or otherwise support a means for receiving, from the UE, a second announcement message indicating that a set of one or more network coding devices has been selected, where the second announcement message is transmitted after a first time duration for selecting network coding devices.

In some examples, the wireless device is included in the set of one or more network coding devices for the UE, and the confirmation message component 1230 may be configured as or otherwise support a means for transmitting, to the UE, a second confirmation message in response to the second announcement message, the second confirmation message indicating that the wireless device will serve as the network coding device for retransmitting the packets originally transmitted from the UE.

In some examples, the second announcement message includes an identifier for each network coding device of the set of one or more network coding devices.

In some examples, to support transmitting the confirmation message, the confirmation message component 1230 may be configured as or otherwise support a means for transmitting the confirmation message after a backoff time, the confirmation message indicating that the wireless device will serve as the network coding device, where the wireless device serves as the network coding device for the UE based on the confirmation message.

In some examples, the confirmation message includes an indication that the confirmation message is associated with a claim for the wireless device to be the network coding device and an identifier of the wireless device.

In some examples, the confirmation message control information component 1235 may be configured as or otherwise support a means for randomly selecting the backoff time from a range of time durations.

In some examples, the confirmation message control information component 1235 may be configured as or otherwise support a means for receiving, from a network entity, a message indicating the range of time durations.

In some examples, the range of time durations is preconfigured.

In some examples, the confirmation message control information component 1235 may be configured as or otherwise support a means for computing the backoff time based on a parameter, a score, and a slot duration.

In some examples, the score is based on a weighted sum of criteria indicated via the announcement message for which the wireless device satisfies.

In some examples, the parameter is configured with a network device or preconfigured.

In some examples, the backoff time is equal to a predefined value based on the wireless device serving as an existing network coding device.

In some examples, the confirmation message precludes other wireless devices from serving as the network coding device.

In some examples, the announcement message includes an indication of a quantity of network coding devices requested for the UE, a speed threshold, a remaining power threshold, an available buffer size threshold, a computational load threshold, a reference signal received power threshold, or any combination thereof.

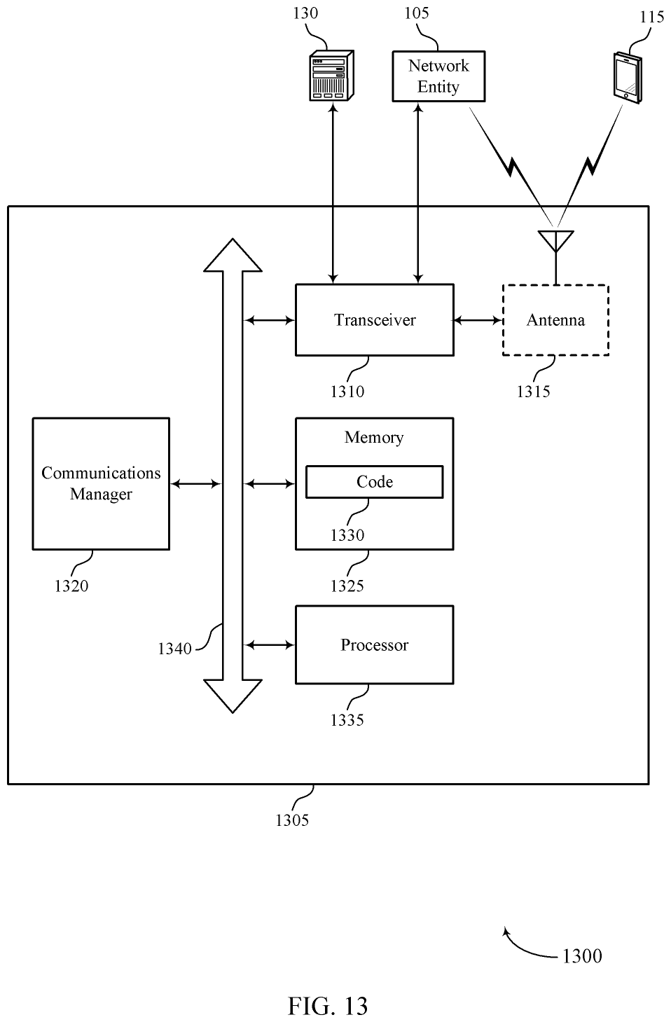

FIG. 13 shows a diagram of a system 1300 including a device 1305 that supports encoder selection for network coding in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting encoder selection for network coding). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a wireless device in accordance with examples as disclosed herein. For example, the communications manager 1320 may be configured as or otherwise support a means for receiving, from a UE, an announcement message including a request for at least one wireless device to serve as a network coding device for retransmitting packets originally transmitted from the UE. The communications manager 1320 may be configured as or otherwise support a means for transmitting, to the UE, a confirmation message in response to the announcement message, where the confirmation message indicates that the wireless device or another wireless device is capable of serving as the network coding device.

By including or configuring the communications manager 1320 in accordance with examples as described herein, the device 1305 may support techniques for improved communication reliability, improved user experience related to reduced processing, reduced power consumption, more efficient utilization of communication resources, improved coordination between devices, and improved utilization of processing capability, among other examples.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of encoder selection for network coding as described herein, or the processor 1335 and the memory 1325 may be otherwise configured to perform or support such operations.

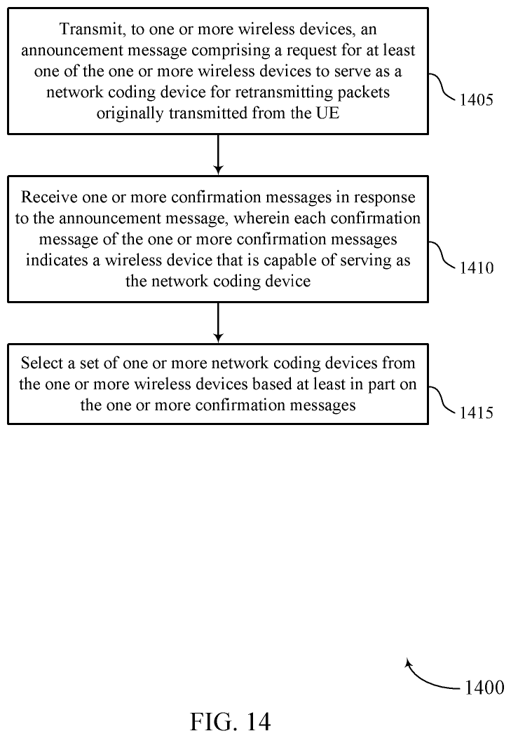

FIG. 14 shows a flowchart illustrating a method 1400 that supports encoder selection for network coding in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, to one or more wireless devices, an announcement message including a request for at least one of the one or more wireless devices to serve as a network coding device for retransmitting packets originally transmitted from the UE. The operations of 1405 may be performed in accordance with examples as disclosed herein. In some examples, aspects of the operations of 1405 may be performed by an announcement message component 825 as described with reference to FIG. 8.

At 1410, the method may include receiving one or more confirmation messages in response to the announcement message, where each confirmation message of the one or more confirmation messages indicates a wireless device that is capable of serving as the network coding device. The operations of 1410 may be performed in accordance with examples as disclosed herein. In some examples, aspects of the operations of 1410 may be performed by a confirmation message component 830 as described with reference to FIG. 8.

At 1415, the method may include selecting a set of one or more network coding devices from the one or more wireless devices based on the one or more confirmation messages. The operations of 1415 may be performed in accordance with examples as disclosed herein. In some examples, aspects of the operations of 1415 may be performed by a network coding device selection component 835 as described with reference to FIG. 8.

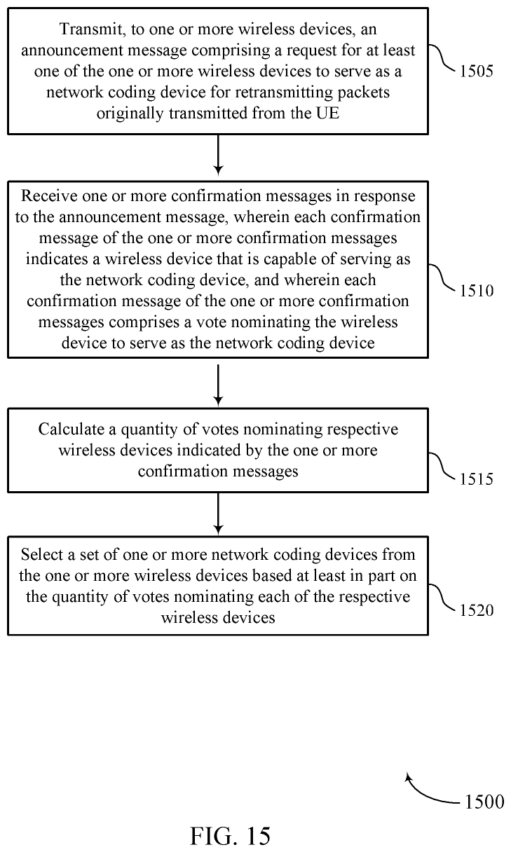

FIG. 15 shows a flowchart illustrating a method 1500 that supports encoder selection for network coding in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting, to one or more wireless devices, an announcement message including a request for at least one of the one or more wireless devices to serve as a network coding device for retransmitting packets originally transmitted from the UE. The operations of 1505 may be performed in accordance with examples as disclosed herein. In some examples, aspects of the operations of 1505 may be performed by an announcement message component 825 as described with reference to FIG. 8.

At 1510, the method may include receiving one or more confirmation messages in response to the announcement message, where each confirmation message of the one or more confirmation messages indicates a wireless device that is capable of serving as the network coding device, and where each confirmation message of the one or more confirmation messages includes a vote nominating the wireless device to serve as the network coding device. The operations of 1510 may be performed in accordance with examples as disclosed herein. In some examples, aspects of the operations of 1510 may be performed by a confirmation message component 830 as described with reference to FIG. 8.

At 1515, the method may include calculating, by the UE, a quantity of votes nominating respective wireless devices indicated via the one or more confirmation messages. The operations of 1515 may be performed in accordance with examples as disclosed herein. In some examples, aspects of the operations of 1515 may be performed by a confirmation message component 830 as described with reference to FIG. 8.

At 1520, the method may include selecting a set of one or more network coding devices from the one or more wireless devices based on the quantity of votes nominating each of the respective wireless devices. The operations of 1520 may be performed in accordance with examples as disclosed herein. In some examples, aspects of the operations of 1520 may be performed by a network coding device selection component 835 as described with reference to FIG. 8.

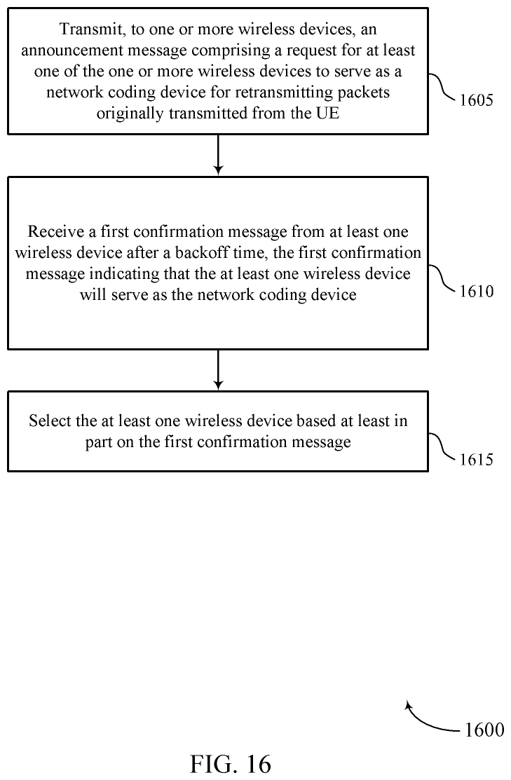

FIG. 16 shows a flowchart illustrating a method 1600 that supports encoder selection for network coding in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting, to one or more wireless devices, an announcement message including a request for at least one of the one or more wireless devices to serve as a network coding device for retransmitting packets originally transmitted from the UE. The operations of 1605 may be performed in accordance with examples as disclosed herein. In some examples, aspects of the operations of 1605 may be performed by an announcement message component 825 as described with reference to FIG. 8.

At 1610, the method may include receiving a first confirmation message from at least one wireless device after a backoff time, the first confirmation message indicating that the at least one wireless device will serve as the network coding device. The operations of 1610 may be performed in accordance with examples as disclosed herein. In some examples, aspects of the operations of 1610 may be performed by a confirmation message component 830 as described with reference to FIG. 8.

At 1615, the method may include selecting the at least one wireless device based on the first confirmation message. The operations of 1615 may be performed in accordance with examples as disclosed herein. In some examples, aspects of the operations of 1615 may be performed by a network coding device selection component 835 as described with reference to FIG. 8.

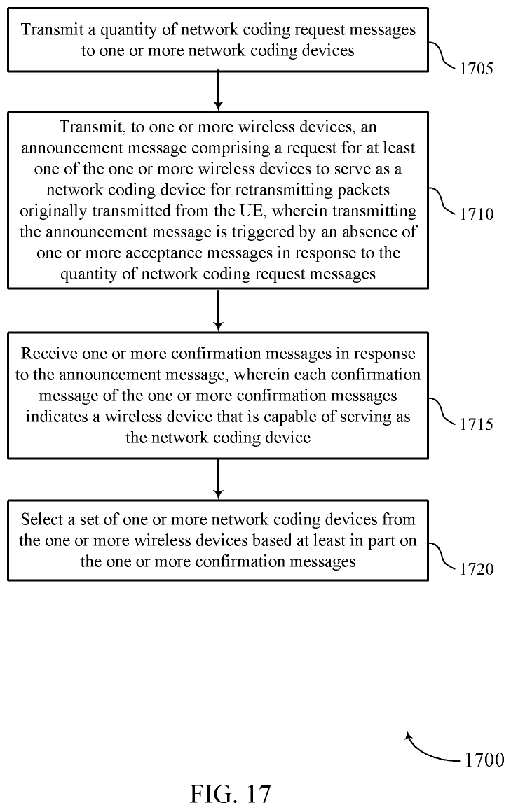

FIG. 17 shows a flowchart illustrating a method 1700 that supports encoder selection for network coding in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include transmitting a quantity of network coding request messages to one or more network coding devices. The operations of 1705 may be performed in accordance with examples as disclosed herein. In some examples, aspects of the operations of 1705 may be performed by a network coding request message component 845 as described with reference to FIG. 8.

At 1710, the method may include transmitting, to one or more wireless devices, an announcement message including a request for at least one of the one or more wireless devices to serve as a network coding device for retransmitting packets originally transmitted from the UE, where transmitting the announcement message is triggered via an absence of one or more acceptance messages in response to the quantity of network coding request messages. The operations of 1710 may be performed in accordance with examples as disclosed herein. In some examples, aspects of the operations of 1710 may be performed by an announcement message component 825 as described with reference to FIG. 8.

At 1715, the method may include receiving one or more confirmation messages in response to the announcement message, where each confirmation message of the one or more confirmation messages indicates a wireless device that is capable of serving as the network coding device. The operations of 1715 may be performed in accordance with examples as disclosed herein. In some examples, aspects of the operations of 1715 may be performed by a confirmation message component 830 as described with reference to FIG. 8.

At 1720, the method may include selecting a set of one or more network coding devices from the one or more wireless devices based on the one or more confirmation messages. The operations of 1720 may be performed in accordance with examples as disclosed herein. In some examples, aspects of the operations of 1720 may be performed by a network coding device selection component 835 as described with reference to FIG. 8.

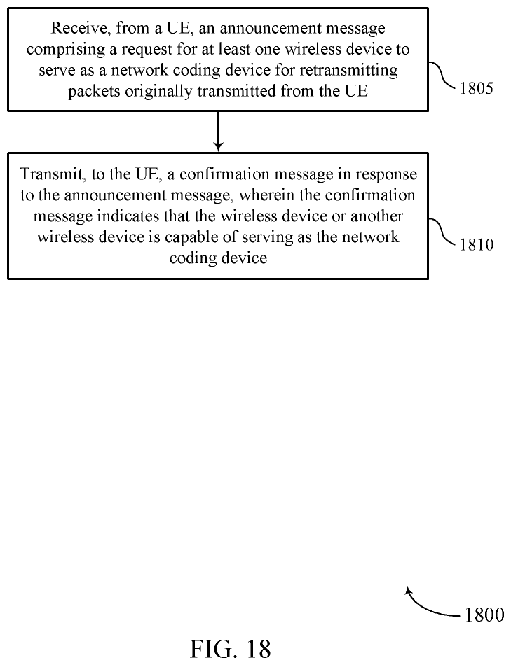

FIG. 18 shows a flowchart illustrating a method 1800 that supports encoder selection for network coding in accordance with one or more aspects of the present disclosure. The operations of the method 1800 may be implemented by a UE or a network entity or its components as described herein. For example, the operations of the method 1800 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include receiving, from a UE, an announcement message including a request for at least one wireless device to serve as a network coding device for retransmitting packets originally transmitted from the UE. The operations of 1805 may be performed in accordance with examples as disclosed herein. In some examples, aspects of the operations of 1805 may be performed by an announcement message component 825 or an announcement message component 1225 as described with reference to FIGS. 8 and 12.

At 1810, the method may include transmitting, to the UE, a confirmation message in response to the announcement message, where the confirmation message indicates that the wireless device or another wireless device is capable of serving as the network coding device. The operations of 1810 may be performed in accordance with examples as disclosed herein. In some examples, aspects of the operations of 1810 may be performed by a confirmation message component 830 or a confirmation message component 1230 as described with reference to FIGS. 8 and 12.

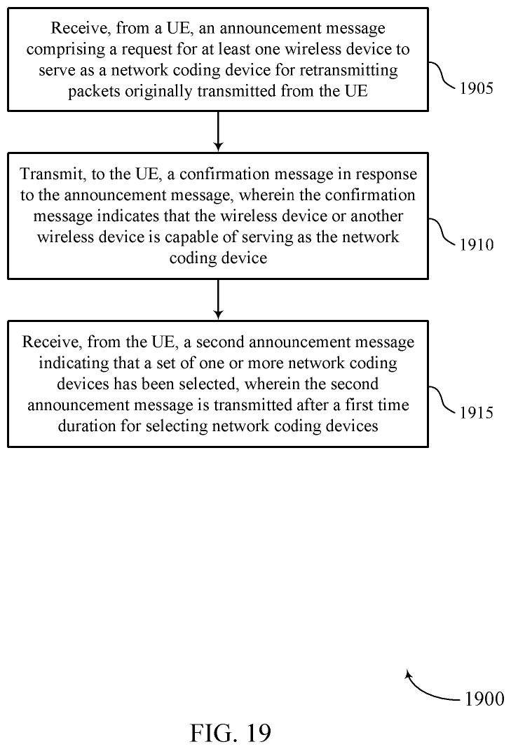

FIG. 19 shows a flowchart illustrating a method 1900 that supports encoder selection for network coding in accordance with one or more aspects of the present disclosure. The operations of the method 1900 may be implemented by a UE or a network entity or its components as described herein. For example, the operations of the method 1900 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include receiving, from a UE, an announcement message including a request for at least one wireless device to serve as a network coding device for retransmitting packets originally transmitted from the UE. The operations of 1905 may be performed in accordance with examples as disclosed herein. In some examples, aspects of the operations of 1905 may be performed by an announcement message component 825 or an announcement message component 1225 as described with reference to FIGS. 8 and 12.

At 1910, the method may include transmitting, to the UE, a confirmation message in response to the announcement message, where the confirmation message indicates that the wireless device or another wireless device is capable of serving as the network coding device. The operations of 1910 may be performed in accordance with examples as disclosed herein. In some examples, aspects of the operations of 1910 may be performed by a confirmation message component 830 or a confirmation message component 1230 as described with reference to FIGS. 8 and 12.

At 1915, the method may include receiving, from the UE, a second announcement message indicating that a set of one or more network coding devices has been selected, where the second announcement message is transmitted after a first time duration for selecting network coding devices. The operations of 1915 may be performed in accordance with examples as disclosed herein. In some examples, aspects of the operations of 1915 may be performed by an announcement message component 825 or an announcement message component 1225 as described with reference to FIGS. 8 and 12.

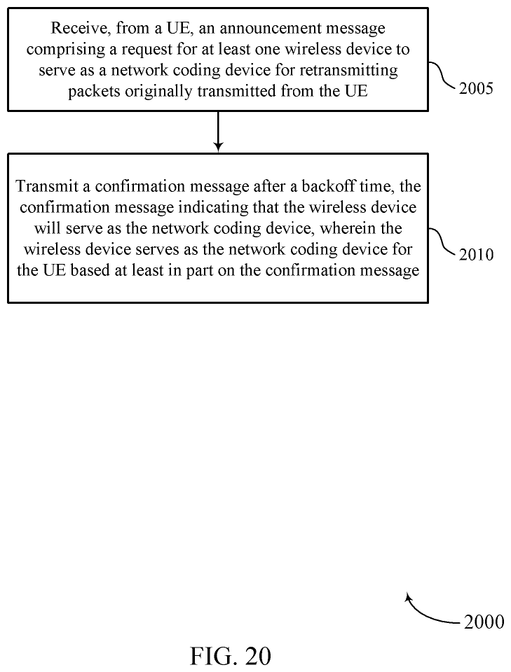

FIG. 20 shows a flowchart illustrating a method 2000 that supports encoder selection for network coding in accordance with one or more aspects of the present disclosure. The operations of the method 2000 may be implemented by a UE or a network entity or its components as described herein. For example, the operations of the method 2000 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include receiving, from a UE, an announcement message including a request for at least one wireless device to serve as a network coding device for retransmitting packets originally transmitted from the UE. The operations of 2005 may be performed in accordance with examples as disclosed herein. In some examples, aspects of the operations of 2005 may be performed by an announcement message component 825 or an announcement message component 1225 as described with reference to FIGS. 8 and 12.

At 2010, the method may include transmitting a confirmation message after a backoff time, the confirmation message indicating that the wireless device will serve as the network coding device, where the wireless device serves as the network coding device for the UE based on the confirmation message. The operations of 2010 may be performed in accordance with examples as disclosed herein. In some examples, aspects of the operations of 2010 may be performed by a confirmation message component 830 or a confirmation message component 1230 as described with reference to FIGS. 8 and 12.

The following provides an overview of aspects of the present disclosure:

Aspect 1: A method for wireless communication at a UE, comprising: transmitting, to one or more wireless devices, an announcement message comprising a request for at least one of the one or more wireless devices to serve as a network coding device for retransmitting packets originally transmitted from the UE; receiving one or more confirmation messages in response to the announcement message, wherein each confirmation message of the one or more confirmation messages indicates a wireless device that is capable of serving as the network coding device; and selecting a set of one or more network coding devices from the one or more wireless devices based at least in part on the one or more confirmation messages.

Aspect 2: The method of aspect 1, wherein each confirmation message of the one or more confirmation messages comprises a vote nominating the wireless device to serve as the network coding device, the method further comprising: calculating, by the UE, a quantity of votes nominating respective wireless devices indicated via the one or more confirmation messages, wherein the set of one or more network coding devices is selected based at least in part on the quantity of votes nominating each of the respective wireless devices.

Aspect 3: The method of aspect 2, wherein selecting the set of one or more network coding devices comprises: calculating, by the UE, that a first wireless device and a second wireless device of the one or more wireless devices have a same quantity of votes based at least in part on the one or more confirmation messages; and randomly selecting the first wireless device or the second wireless device in the set of one or more network coding devices based at least in part on the calculation.

Aspect 4: The method of any of aspects 2 through 3, wherein each confirmation message further comprises an identifier of the wireless device, a weighted value of the wireless device, an indication that the confirmation message includes the vote, or any combination thereof.

Aspect 5: The method of any of aspects 2 through 4, wherein the one or more confirmation messages are received during a first time duration, the method further comprising: transmitting, to the set of one or more network coding devices, a second announcement message indicating that the set of one or more network coding devices has been selected, wherein the second announcement message is transmitted after the first time duration.

Aspect 6: The method of aspect 5, wherein the second announcement message includes an identifier for each network coding device of the set of one or more network coding devices.

Aspect 7: The method of any of aspects 5 through 6, further comprising: receiving, from at least one selected network coding device of the set of one or more network coding devices, a second confirmation message in response to the second announcement message, the second confirmation message indicating that the at least one selected network coding device will serve as the network coding device for retransmitting the packets originally transmitted from the UE.

Aspect 8: The method of any of aspects 5 through 7, further comprising: determining an absence of a second confirmation message received from at least one network coding device of the set of one or more network coding devices in response to the second announcement message; and transmitting a third announcement message based at least in part on the absence of the second confirmation message, the third announcement message comprising an indication of a modified set of one or more network coding devices.

Aspect 9: The method of any of aspects 5 through 8, further comprising: determining that a quantity of second confirmation messages from the set of one or more network coding devices fails to satisfy a threshold quantity of confirmation messages; and transmitting a third announcement message based at least in part on the quantity of the second confirmation messages failing to satisfy the threshold quantity of confirmation messages, the third announcement message comprising an indication of a modified set of one or more network coding devices.

Aspect 10: The method of any of aspect 1, wherein receiving the one or more confirmation messages comprises: receiving a first confirmation message from at least one wireless device after a backoff time, the first confirmation message indicating that the at least one wireless device will serve as the network coding device, wherein the at least one wireless device is selected for the set of one or more network coding devices based at least in part on the first confirmation message.

Aspect 11: The method of aspect 10, further comprising: transmitting a second announcement message indicating that the set of one or more network coding devices has been selected based at least in part on receiving the first confirmation message.

Aspect 12: The method of any of aspects 10 through 11, wherein the first confirmation message comprises an indication that the first confirmation message is associated with a claim for the at least one wireless device to be the network coding device and an identifier of the at least one wireless device.

Aspect 13: The method of any of aspects 10 through 12, wherein the first confirmation message precludes other wireless devices from serving as the network coding device.

Aspect 14: The method of any of aspects 10 through 13, wherein the backoff time comprises a time duration randomly selected from a range of time durations.

Aspect 15: The method of any of aspects 10 through 14, wherein the backoff time comprises a time duration that is calculated based at least in part on a parameter, a score, and a slot duration.

Aspect 16: The method of aspect 15, wherein the score is based at least in part on a weighted sum of criteria indicated by the announcement message for which the at least one wireless device satisfies.

Aspect 17: The method of any of aspects 1 through 16, further comprising: storing a list of the set of one or more network coding devices based at least in part on selecting the set of one or more network coding devices.

Aspect 18: The method of any of aspects 1 through 17, further comprising: transmitting a quantity of network coding request messages to one or more network coding devices, wherein transmitting the announcement message is triggered via an absence of one or more acceptance messages in response to the quantity of network coding request messages.

Aspect 19: The method of aspect 18, further comprising: receiving, from a network entity, a message comprising an indication of the quantity of network coding request messages.

Aspect 20: The method of any of aspects 18 through 19, wherein the quantity of network coding request messages is preconfigured.

Aspect 21: The method of any of aspects 1 through 20, further comprising: determining an absence of network coding packets, or encoder claiming packets, or both, for a second time duration, wherein transmitting the announcement message is triggered via the absence of the network coding packets, or the encoder claiming packets, or both, for the second time duration.

Aspect 22: The method of aspect 21, further comprising: receiving, from a network entity, a message comprising an indication of the second time duration.

Aspect 23: The method of aspect 21, wherein the second time duration is preconfigured.

Aspect 24: The method of any of aspects 1 through 10 and 12 through 23, further comprising: receiving one or more announcement messages from one or more other UEs during a third time duration; and refraining from transmitting a second announcement message based at least in part on the one or more announcement messages received during the third time duration.

Aspect 25: The method of aspect 24, further comprising: receiving, from a network entity, a message indicating the third time duration.

Aspect 26: The method of aspect 24, wherein the third time duration is preconfigured.

Aspect 27: The method of any of aspects 1 through 26, further comprising: receiving, from a first network coding device and in response to the announcement message, a message indicating that the first network coding device serves as an existing network coding device.

Aspect 28: The method of any of aspects 1 through 27, further comprising: monitoring for one or more existing network coding devices; and determining an absence of an existing network coding device based at least in part on the monitoring, wherein transmitting the announcement message is based at least in part on determining the absence of the existing network coding device.

Aspect 29: The method of aspect 28, wherein determining the absence comprises: determining that a first network coding device ceases operation as the existing network coding device.

Aspect 30: The method of any of aspects 1 through 29, wherein each network coding device of the set of one or more network coding devices satisfy one or more criteria indicated via the announcement message.

Aspect 31: The method of aspect 30, wherein the one or more criteria comprise a speed threshold, a remaining power threshold, an available buffer size threshold, a computational load threshold, a reference signal received power threshold, or any combination thereof.

Aspect 32: The method of aspect 31, wherein the one or more criteria are configured by a network entity or preconfigured.

Aspect 33: The method of any of aspects 1 through 32, wherein the announcement message comprises an indication of a quantity of network coding devices requested from the UE, selecting the set of one or more network coding devices is based at least in part on the quantity of network coding devices requested from the UE.

Aspect 34: The method of any of aspects 1 through 33, wherein the announcement message comprises an indication that the announcement message is associated with a beginning of a network coding device selection procedure by the UE.

Aspect 35: The method of any of aspects 1 through 34, wherein the announcement message comprises a network coding request message including a request for retransmitting the packets originally transmitted from the UE.

Aspect 36: A method for wireless communication at a wireless device, comprising: receiving, from a UE, an announcement message comprising a request for at least one wireless device to serve as a network coding device for retransmitting packets originally transmitted from the UE; and transmitting, to the UE, a confirmation message in response to the announcement message, wherein the confirmation message indicates that the wireless device or another wireless device is capable of serving as the network coding device.

Aspect 37: The method of aspect 36, wherein the confirmation message comprises a vote nominating the wireless device or the other wireless device to serve as the network coding device.

Aspect 38: The method of aspect 37, wherein the confirmation message comprises the vote nominating the wireless device based at least in part on an unavailability of one or more other wireless devices to serve as the network coding device.

Aspect 39: The method of any of aspects 37 through 38, wherein the confirmation message further comprises an identifier of the wireless device, a weighted value of the wireless device, an identifier of the other wireless device, a weighted value of the other wireless device, an indication that the confirmation message includes the vote, or any combination thereof.

Aspect 40: The method of any of aspects 37 through 39, further comprising: receiving, from the UE, a second announcement message indicating that a set of one or more network coding devices has been selected, wherein the second announcement message is transmitted after a first time duration for selecting network coding devices.

Aspect 41: The method of aspect 40, wherein the wireless device is included in the set of one or more network coding devices for the UE, the method further comprising: transmitting, to the UE, a second confirmation message in response to the second announcement message, the second confirmation message indicating that the wireless device will serve as the network coding device for retransmitting the packets originally transmitted from the UE.

Aspect 42: The method of any of aspects 40 through 41, wherein the second announcement message includes an identifier for each network coding device of the set of one or more network coding devices.

Aspect 43: The method of aspect 36, wherein transmitting the confirmation message comprises: transmitting the confirmation message after a backoff time, the confirmation message indicating that the wireless device will serve as the network coding device, wherein the wireless device serves as the network coding device for the UE based at least in part on the confirmation message.

Aspect 44: The method of aspect 43, wherein the confirmation message comprises an indication that the confirmation message is associated with a claim by the wireless device to be the network coding device and an identifier of the wireless device.

Aspect 45: The method of any of aspects 43 through 44, further comprising: randomly selecting the backoff time from a range of time durations.

Aspect 46: The method of aspect 45, further comprising: receiving, from a network entity, a message indicating the range of time durations.

Aspect 47: The method of aspect 45, wherein the range of time durations is preconfigured.

Aspect 48: The method of aspect 43, further comprising: computing the backoff time based at least in part on a parameter, a score, and a slot duration.

Aspect 49: The method of aspect 48, wherein the score is based at least in part on a weighted sum of criteria indicated by the announcement message for which the wireless device satisfies.

Aspect 50: The method of any of aspects 48 through 49, wherein the parameter is configured by a network entity or preconfigured.

Aspect 51: The method of any of aspects 43 through 50, wherein the backoff time is equal to a predefined value based at least in part on the wireless device serving as an existing network coding device.

Aspect 52: The method of any of aspects 43 through 51, wherein the confirmation message precludes other wireless devices from serving as the network coding device.

Aspect 53: The method of any of aspects 36 through 52, wherein the announcement message comprises an indication of a quantity of network coding devices requested by the UE, a speed threshold, a remaining power threshold, an available buffer size threshold, a computational load threshold, a reference signal received power threshold, or any combination thereof.

Aspect 54: An apparatus for wireless communication at a UE, comprising a processor; memory coupled with the processor; and instructions stored in the memory and executable by the processor to cause the apparatus to perform a method of any of aspects 1 through 35.

Aspect 55: An apparatus for wireless communication at a UE, comprising at least one means for performing a method of any of aspects 1 through 35.

Aspect 56: A non-transitory computer-readable medium storing code for wireless communication at a UE, the code comprising instructions executable by a processor to perform a method of any of aspects 1 through 35.

Aspect 57: An apparatus for wireless communication at a wireless device, comprising a processor; memory coupled with the processor; and instructions stored in the memory and executable by the processor to cause the apparatus to perform a method of any of aspects 36 through 53.

Aspect 58: An apparatus for wireless communication at a wireless device, comprising at least one means for performing a method of any of aspects 36 through 53.

Aspect 59: A non-transitory computer-readable medium storing code for wireless communication at a wireless device, the code comprising instructions executable by a processor to perform a method of any of aspects 36 through 53.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to one or more wireless devices, an announcement message comprising a request for at least one of the one or more wireless devices to serve as a network coding device for retransmitting packets originally transmitted from the UE;
receiving one or more confirmation messages in response to the announcement message, wherein each confirmation message of the one or more confirmation messages indicates a wireless device that is capable of serving as the network coding device; and
selecting a set of one or more network coding devices from the one or more wireless devices based at least in part on the one or more confirmation messages.

2. The method of claim 1, wherein each confirmation message of the one or more confirmation messages comprises a vote nominating the wireless device to serve as the network coding device, the method further comprising:
calculating, by the UE, a quantity of votes nominating respective wireless devices indicated via the one or more confirmation messages, wherein the set of one or more network coding devices is selected based at least in part on the quantity of votes nominating each of the respective wireless devices.

3. The method of claim 2, wherein selecting the set of one or more network coding devices comprises:
calculating, by the UE, that a first wireless device and a second wireless device of the one or more wireless devices have a same quantity of votes based at least in part on the one or more confirmation messages; and
randomly selecting the first wireless device or the second wireless device in the set of one or more network coding devices based at least in part on the calculation.

4. The method of claim 2, wherein each confirmation message further comprises an identifier of the wireless device, a weighted value of the wireless device, an indication that the confirmation message includes the vote, or any combination thereof.

5. The method of claim 2, wherein the one or more confirmation messages are received during a first time duration, the method further comprising:
transmitting, to the set of one or more network coding devices, a second announcement message indicating that the set of one or more network coding devices has been selected, wherein the second announcement message is transmitted after the first time duration and includes an identifier for each network coding device of the set of one or more network coding devices.

6. The method of claim 5, further comprising:
receiving, from at least one selected network coding device of the set of one or more network coding devices, a second confirmation message in response to the second announcement message, the second confirmation message indicating that the at least one selected network coding device will serve as the network coding device for retransmitting the packets originally transmitted from the UE.

7. The method of claim 5, further comprising:
determining an absence of a second confirmation message received from at least one network coding device of the set of one or more network coding devices in response to the second announcement message; and
transmitting a third announcement message based at least in part on the absence of the second confirmation message, the third announcement message comprising an indication of a modified set of one or more network coding devices.

8. The method of claim 5, further comprising:
determining that a quantity of second confirmation messages from the set of one or more network coding devices fails to satisfy a threshold quantity of confirmation messages; and
transmitting a third announcement message based at least in part on the quantity of the second confirmation messages failing to satisfy the threshold quantity of confirmation messages, the third announcement message comprising an indication of a modified set of one or more network coding devices.

9. The method of claim 1, wherein receiving the one or more confirmation messages comprises:
receiving a first confirmation message from at least one wireless device after a backoff time, the first confirmation message indicating that the at least one wireless device will serve as the network coding device, wherein the at least one wireless device is selected for the set of one or more network coding devices based at least in part on the first confirmation message, wherein the first confirmation message precludes other wireless devices from serving as the network coding device.

10. The method of claim 9, further comprising:
transmitting a second announcement message indicating that the set of one or more network coding devices has been selected based at least in part on receiving the first confirmation message.

11. The method of claim 9, wherein the first confirmation message comprises an indication that the first confirmation message is associated with a claim for the at least one wireless device to be the network coding device and an identifier of the at least one wireless device.

12. The method of claim 9, wherein the backoff time comprises a time duration randomly selected from a range of time durations; or
the backoff time comprises a time duration that is calculated based at least in part on a parameter, a score, and a slot duration, wherein the score is based at least in part on a weighted sum of criteria indicated by the announcement message for which the at least one wireless device satisfies.

13. The method of claim 1, further comprising:
storing a list of the set of one or more network coding devices based at least in part on selecting the set of one or more network coding devices.

14. The method of claim 1, further comprising:
transmitting a quantity of network coding request messages to one or more network coding devices, wherein transmitting the announcement message is triggered via an absence of one or more acceptance messages in response to the quantity of network coding request messages.

15. The method of claim 1, further comprising:
determining an absence of network coding packets, or encoder claiming packets, or both, for a second time duration, wherein transmitting the announcement message is triggered via the absence of the network coding packets, or the encoder claiming packets, or both, for the second time duration.

16. The method of claim 1, further comprising:
receiving one or more announcement messages from one or more other UEs during a third time duration; and
refraining from transmitting a second announcement message based at least in part on the one or more announcement messages received during the third time duration.

17. The method of claim 1, further comprising:
monitoring for one or more existing network coding devices; and
determining an absence of an existing network coding device based at least in part on the monitoring, wherein transmitting the announcement message is based at least in part on determining the absence of the existing network coding device.

18. The method of claim 1, wherein each network coding device of the set of one or more network coding devices satisfy one or more criteria indicated via the announcement message.

19. The method of claim 18, wherein the one or more criteria comprise a speed threshold, a remaining power threshold, an available buffer size threshold, a computational load threshold, a reference signal received power threshold, or any combination thereof.

20. The method of claim 1, wherein:
the announcement message comprises an indication of a quantity of network coding devices requested from the UE; and
selecting the set of one or more network coding devices is based at least in part on the quantity of network coding devices requested from the UE.

21. The method of claim 1, wherein the announcement message comprises a network coding request message including a request for retransmitting the packets originally transmitted from the UE.

22. A method for wireless communication at a wireless device, comprising:
receiving, from a user equipment (UE), an announcement message comprising a request for at least one wireless device to serve as a network coding device for retransmitting packets originally transmitted from the UE; and
transmitting, to the UE, a confirmation message in response to the announcement message, wherein the confirmation message indicates that the wireless device or another wireless device is capable of serving as the network coding device.

23. The method of claim 22, wherein the confirmation message comprises a vote nominating the wireless device or the other wireless device to serve as the network coding device.

24. The method of claim 23, further comprising:
receiving, from the UE, a second announcement message indicating that a set of one or more network coding devices has been selected, wherein the second announcement message is transmitted after a first time duration for selecting network coding devices.

25. The method of claim 24, wherein the wireless device is included in the set of one or more network coding devices for the UE, the method further comprising:
transmitting, to the UE, a second confirmation message in response to the second announcement message, the second confirmation message indicating that the wireless device will serve as the network coding device for retransmitting the packets originally transmitted from the UE.

26. The method of claim 22, wherein transmitting the confirmation message comprises:
transmitting the confirmation message after a backoff time, the confirmation message indicating that the wireless device will serve as the network coding device, wherein the wireless device serves as the network coding device for the UE based at least in part on the confirmation message.

27. The method of claim 26, further comprising:
randomly selecting the backoff time from a range of time durations; or
computing the backoff time based at least in part on a parameter, a score, and a slot duration.

28. The method of claim 26, wherein the backoff time is equal to a predefined value based at least in part on the wireless device serving as an existing network coding device.

29. An apparatus for wireless communication at a user equipment (UE), comprising:
a processor;
memory coupled with the processor; and
instructions stored in the memory and executable using the processor to cause the apparatus to:
transmit, to one or more wireless devices, an announcement message comprising a request for at least one of the one or more wireless devices to serve as a network coding device for retransmitting packets originally transmitted from the UE;
receive one or more confirmation messages in response to the announcement message, wherein each confirmation message of the one or more confirmation messages indicates a wireless device that is capable of serving as the network coding device; and
select a set of one or more network coding devices from the one or more wireless devices based at least in part on the one or more confirmation messages.

30. An apparatus for wireless communication at a wireless device, comprising:
a processor;
memory coupled with the processor; and
instructions stored in the memory and executable using the processor to cause the apparatus to:
receive, from a user equipment (UE), an announcement message comprising a request for at least one wireless device to serve as a network coding device for retransmitting packets originally transmitted from the UE; and
transmit, to the UE, a confirmation message in response to the announcement message, wherein the confirmation message indicates that the wireless device or another wireless device is capable of serving as the network coding device.
